(19) United States
(12) Patent Application Publication
(10) Pub. No.: US 2023/0094097 A1
(43) Pub. Date: Mar. 30, 2023

(54) METHOD, CONTROLLER, AND COMPUTER-READABLE MEDIUM FOR DETERMINING AUTHORIZED TOKEN TRANSFERS IN A TOKENIZED TRANSFER NETWORK

(71) Applicant: AGORA INTELLIGENCE, INC., Santa Clara, CA (US)

(72) Inventor: Kevin HOPKINS, Sandy, UT (US)

(21) Appl. No.: 17/957,988

(22) Filed: Sep. 30, 2022

Related U.S. Application Data
(60) Provisional application No. 63/250,919, filed on Sep. 30, 2021.
(60) Provisional application No. 63/331,150, filed on Apr. 14, 2022.
(60) Provisional application No. 63/331,156, filed on Apr. 14, 2022.

(51) Int. Cl. H04L 9/40

(52) U.S. Cl. CPC H04L 63/0853

(57) ABSTRACT

A method, controller, and computer-readable medium for determining authorized token transfers on a tokenized transfer network including determining network-host parameters corresponding to a network-host of the tokenized transfer network, determining network-client parameters corresponding to a network-client registered with the tokenized transfer network, generating a parameterized model based at least in part on the network-host parameters and the network-client parameters, the parameterized model being generated by integrating the network-host parameters and the network-client parameters into an authorized token transfer generation subroutine, receiving, by the controller, transfer data structures, each transfer data structure identifying a first entity having requirements associated with a transfer to a second entity, the second entity having collection authority to receive the transfer from the first entity, and one or more transfer parameters governing the transfer, and applying the parameterized model to the transfer data structures to determine network-client adjustment rates and authorized token transfers.

### RELATED APPLICATION DATA

This application claims priority to U.S. Provisional Application No. 63/250,919 filed Sep. 30, 2021, U.S. Provisional Application No. 63/331,150 filed Apr. 14, 2022, and U.S. Provisional Application No. 63/331,156 filed Apr. 14, 2022, the disclosures of which are hereby incorporated by reference in their entirety.

### BACKGROUND

Network hosts and network administrators frequently utilize different parameters governing the computation and initiation of transfers and related transfer conditions than the network clients that participate in the transfers. Additionally, the transfer determination process and transfer conditions can be dependent on data pertaining to additional entities. There is currently no way to efficiently integrate data pertaining to network administrator parameters, network client parameters, and additional entity data to compute, authorize, and initiate transfers.

### BRIEF DESCRIPTION OF THE DRAWINGS

FIG. 1 illustrates a flowchart for determining authorized token transfers performed by a controller of a tokenized transfer network according to an exemplary embodiment.

FIG. 2 illustrates a system chart of a tokenized transfer network for determining authorized token transfers according to an exemplary embodiment.

FIGS. 3A-3C illustrate interface screens for inputting administrator parameters according to an exemplary embodiment.

FIGS. 4A-4B illustrate interface screens for inputting funder parameters according to an exemplary embodiment.

FIG. 5 illustrates a setting page of a Funder portal that shows several Funder parameters according to an exemplary embodiment.

FIG. 6 illustrates the process for generating the parameterized model according to an exemplary embodiment.

FIG. 7 illustrates a system chart showing the transfer of transfer data structures to the network host and the parameterized model according to an exemplary embodiment.

FIG. 8 illustrates a flowchart for applying the parameterized model to the plurality of transfer data structures to determine a plurality of network-client adjustment rates and a plurality of authorized token transfers according to an exemplary embodiment.

FIG. 9 illustrates a flowchart for applying the parameterized model to the plurality of remaining transfer data structures to determine the plurality of network-client adjustment rates and the plurality of authorized token transfers according to an exemplary embodiment.

FIG. 10 illustrates an example of the buyer profile and receivable/invoice transaction history according to an exemplary embodiment.

FIG. 11 illustrates an example of the seller profile and invoice transaction history according to an exemplary embodiment.

FIG. 12 illustrates a flowchart for another aspect of applying the parameterized pricing model to the plurality of remaining receivables to determine the plurality of discount rates and the plurality of approved offers corresponding to the plurality of approved receivables in the plurality of receivables according to an exemplary embodiment.

FIGS. 13 and 14A-14M illustrate specific calculations in an invoice/receivable based funding context according to an exemplary embodiment.

FIG. 15 illustrates a flowchart for another aspect of applying the parameterized pricing model to the plurality of remaining receivables to determine a plurality of discount rates and a plurality of approved offers corresponding to a plurality of approved receivables in the plurality of receivables according to an exemplary embodiment.

FIG. 16 illustrates a flowchart for iteratively determining authorized token transfers corresponding to remaining transfer data structures in each arrival-time cohort on a rolling basis in chronological order of arrival time of each arrival-time cohort based at least in part on a determination that the authorized token transfer would not result in the current total reverse transfer value exceeding a network-client parameter in the plurality of network-client parameters according to an exemplary embodiment.

FIGS. 17-19 illustrate examples of receivables processing in a receivable/invoice based funding context according to an exemplary embodiment.

FIG. 20 illustrates a flowchart for completing transfers according to an exemplary embodiment. In the receivable/invoice based funding context, this process can be used to complete funding transactions with sellers according to an exemplary embodiment.

FIG. 21 illustrates a flowchart for completing transfers in an aggregated manner according to an exemplary embodiment.

FIG. 22 illustrates a system chart of the overall transfer process after approval according to an exemplary embodiment.

FIG. 23 illustrates a repayment schedule for an illustrative Seller in a receivable/invoice based funding context according to an exemplary embodiment.

FIG. 24 illustrates the components of the specialized computing environment configured to perform the specialized processes described herein.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate also comprise a portion of the invention. However, because such elements do not facilitate a better understanding of the invention, a description of such elements is not provided herein.

Applicant has discovered a method, controller, and computer-readable medium for determining authorized token transfers in a tokenized transfer network. The present system and related techniques can be applied to a variety of contexts. For example, the present system can be utilized in an invoice or receivable transfer context, in which an invoice or receivable is sold by a seller in exchange for funds provided by a funder.

In the context of invoices/receivables, the term seller refers to a company that is selling services/products. The term buyer refers to a company named on the outstanding invoices/receivables that owes an outstanding balance to the seller, typically a customer of the seller. Additionally, the term funder refers to a company or individual that provides funds to the seller in exchange for collection authorization (i.e., collection permissions or the right to collect) for outstanding receivables/invoices owed to the seller.

Invoice-based funding transfer involve funders providing funds to sellers on the basis of invoices owed to the sellers from buyers. While many companies would benefit from invoice-based funding transfers, it is difficult for many funders to obtain or leverage accurate information about buyer and seller companies in order to accurate determine risk and the appropriate level of commissions to charge for funding.

Additionally, many companies that have adequate capital to provide invoice-based funding transfers cannot do so because they lack the technological infrastructure and platform to do so. Each funder company additionally has different tolerance to risk and preferences regarding which sellers they would like finance, making a one-size-fits-all solution impractical.

Furthermore, the process of invoice or receivable based funding transfers itself involves a significant time and resource investment for tasks such as manual underwriting, evaluation of invoices and terms, assessment of risk, assessment of buyer and seller companies, pricing of invoices, and communication and acceptance of offers.

The disclosed system and methods can be implemented in an invoice or receivable based funding transfer system to address the above-mentioned problems. As used herein, the term receivable includes invoices, as well as recurring receivables such as monthly bills due on a services contract.

The present system offers many advantages. Specifically:
Self-service white-labels: all the funder needs to do is set parameters and the white-label deployments can be automatically created.
Automated inclusion of risk-scores and projected days beyond term in the pricing process.
The ability to automatically add grace periods to funding, the unique auto-pricing capability for receivables.
Dynamic creation of fees and the use of tiering arrangements so that the most important fees get paid first and the less important (e.g., Administrator fees) get paid with whatever is left.
The ability of the Funder to set discount rates and create offers merely by defining its desired IRR. The ability to optimally price receivables to generate the Funder's desired IRR.
The ability to dynamically calculate receivable-specific probabilities of delinquency based on aggregates and repayment history.
The use of interconnected exposure limits to automatically determine fundability based on receivable characteristics and funding available.
Auto-ranking of receivables according to parameterized desirability of funding.
The automated receivables queue, which allows for receivables to be financed immediately and automatically rather than requiring human intervention or extensive processing time.
The consolidated repayment methodology.

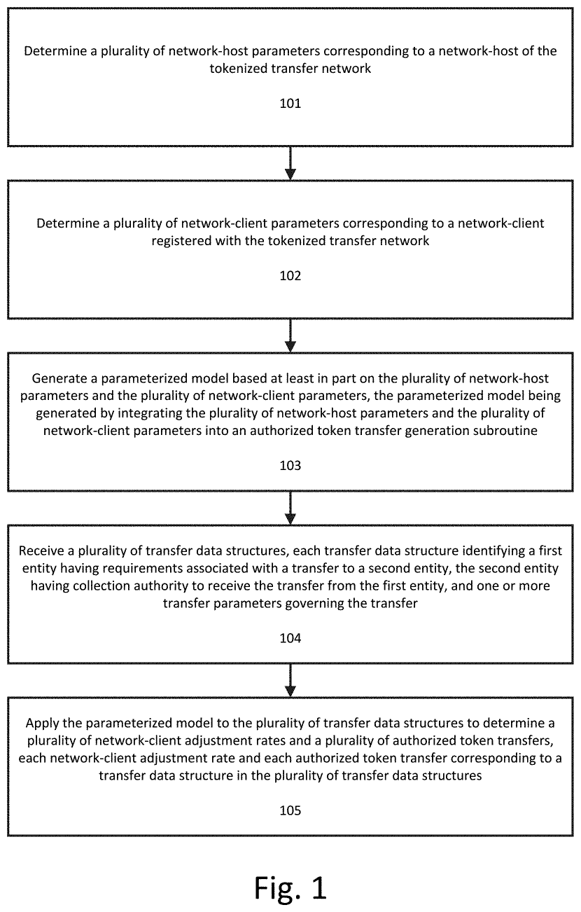

FIG. 1 illustrates a flowchart for determining authorized token transfers performed by a controller of a tokenized transfer network according to an exemplary embodiment. The tokenized transfer network can be hosted on one or more servers of a computer network and can include a network-host, network-clients, and other entities connected to the network.

In a receivable based transfer context, these steps can be used for automatic pricing of receivables on a receivable financing platform with a parameterized pricing model. The receivable financing platform can be hosted on one or more servers of a computer network and accessible to funders, sellers, and buyers through the computer network (e.g., via web portal).

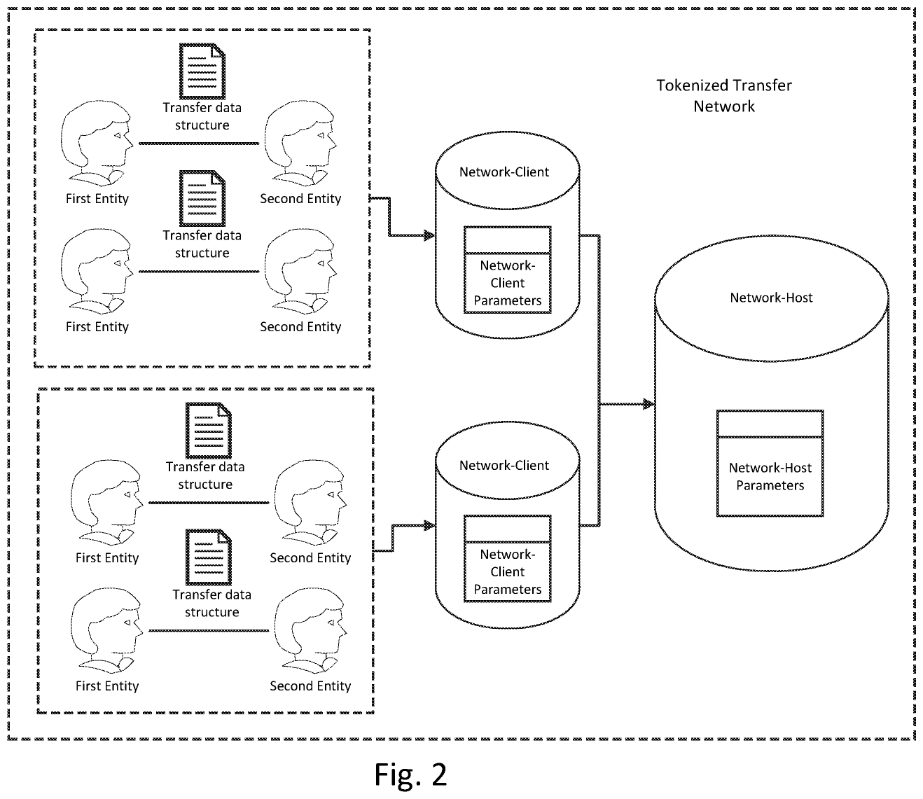

FIG. 2 illustrates a system chart of a tokenized transfer network for determining authorized token transfers according to an exemplary embodiment. As shown in FIG. 2, network-clients can register with and communicate with the network host in order to set up their accounts. Additionally, the network-clients partners and network, which can include first entities and second entities (depending on the deployment) can also communicate with the network-host, either through their corresponding network-clients (e.g. via a portal/account) or by registering directly with the network-host.

As shown in FIG. 2, the network host includes network-host parameters corresponding to a host of the network (i.e., the administrator of the network). Additionally, each network-client can communicate its own set of network-client parameters to the network hose. Furthermore, the first or second entities can communicate transfer data structures to the platform, either directly or through partner network-client accounts.

The network-host parameters and network-client parameters allow for the generation of a parameterized model. Parameterization utilizes elements that, when adjusted, modify each deployments operation, analysis, and calculations, but within a common framework. As a result, a single platform instance can support dozens—or even hundreds—of different deployments. Parameters are used to both customize a deployment at the outset of an engagement and modify the deployment's operation and calculations over time. Each of the network-host and network-client parameters are discussed in greater detail below.

As discussed above, the system can be implemented in a receivable based transfer context. This specific implementation is described throughout this application with reference to the features of the broader technological system in parenthesis. In this case, the system can price receivables (transfer data structures) on a receivable based funding platform (network host) with a parameterized pricing model (parameterized model). Funder companies (network clients) can register with and communicate with the platform in order to set up their accounts. Additionally, the funders partners and network, which can include buyers (first entities) and sellers (second entities) can also communicate with the platform, either through their corresponding funders (e.g. via a funder portal/account) or by registering directly with the receivable based funding platform (also referred to herein as the “platform”).

The platform includes administrator parameters (network-host parameters) corresponding to an administrator (host) of the platform. Additionally, each funder can communicate its own set of funder parameters (network-client parameters) to the platform. Furthermore, the sellers and/or buyers can communicate receivables (transfer data structures) to the platform, either directly or through partner funder accounts.

The administrator parameters and funder parameters allow for the generation of a parameterized pricing model. Parameterization utilizes elements that, when adjusted, modify each deployments operation, analysis, and calculations, but within a common framework. As a result, a single platform instance can support dozens—or even hundreds—of different deployments. Parameters are used to both customize a deployment at the outset of an engagement and modify the deployment's operation and calculations over time. Each of the administrator and funder parameters are discussed in greater detail below.

Returning to FIG. 1, at step 101 a plurality of network-host parameters corresponding to a network-host of the tokenized transfer network. In the receivable based funding context, a plurality of administrator parameters corresponding to an administrator of the platform are determined. The administrator parameters can be determined in a variety of ways. For example, the administrator parameters can be set to some default value, input or modified via a web portal or other interface, and/or be automatically determined based upon some algorithm or process running on the platform or a system connected to the platform on the network.

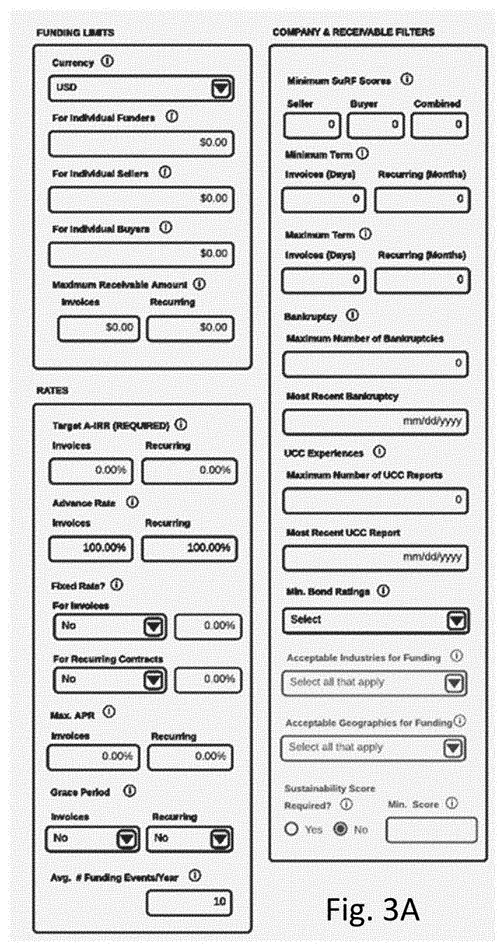

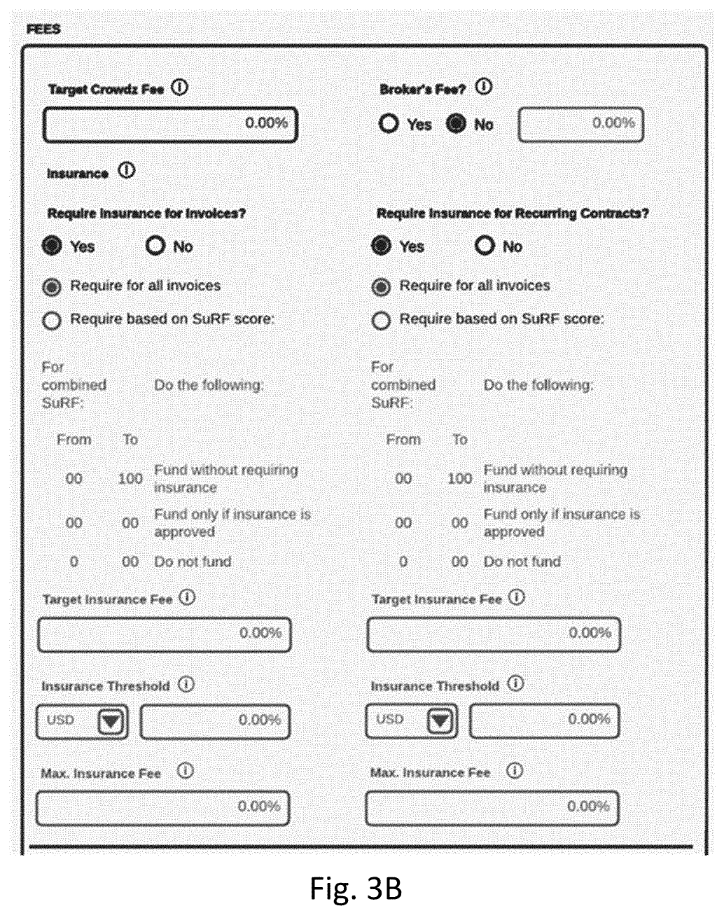

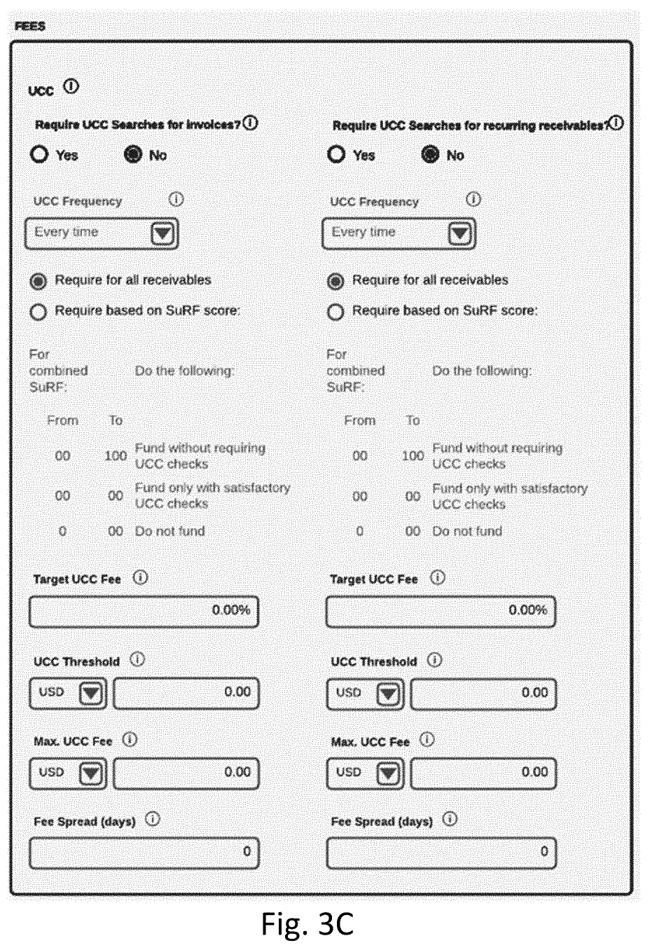

FIGS. 3A-3C illustrate interface screens for inputting administrator parameters according to an exemplary embodiment. Each of these administrator parameters, and other administrator parameters, are explained below.

Network Host/Administrator Parameters

Administrator sets up to 30 overall funding parameters that apply to all Administrator deployments (self-funding, SPV, white-labels, and marketplace) unless overridden by Funder-specific parameters (where relevant). All Administrator variables can be set either globally or on a deployment-by-deployment basis. Note that the numbers in fields without default values are grayed-out initially; numbers in fields with default values, as well as numbers in fields in which entries have been made, are black.

Funding Limits

a. Funding limit for individual Funders. The maximum amount of funding that any one Funder within the Administrator universe is able to have out (i.e., its total financial exposure) at any one time.
This is a numeric entry field in which the currency is selected via a dropdown and monetary value is typed in.
If the currency selected differs from the currency used in a particular deployment, then the value is converted to the deployment's currency and is updated in real-time.
The monetary value has two decimal points (defaulted to “00”) and cannot be less than zero.
This is an optional field: if no value is selected, there is no limit.
There is no default value.

b. Funding limits for individual Sellers. The maximum amount of funding that any one Funder within the Administrator universe is permitted to have out for an individual Seller (i.e., its Seller-specific financial exposure) at any one time.
This is a numeric entry field in which the currency is selected via a dropdown and monetary values are typed in.
If the currency selected differs from the currency used in a particular deployment, then the value is converted to the deployment's currency and is updated in real-time.
The monetary value has two decimal points (defaulted to “00”) and cannot be less than zero.
This is an optional field. If no Seller limit is set, funding for a particular Seller is limited only by the overall Funder limit.
There is no default value.

c. Funding limits for individual Buyers. The maximum amount of funding that any one Funder within the Administrator universe is permitted to have out for an individual Buyer (i.e., its Buyer-specific financial exposure) at any one time.
This is a numeric entry field in which the currency is selected via a dropdown and monetary values are typed in.
If the currency selected differs from the currency used in a particular deployment, then the value is converted to the deployment's currency and is updated in real-time.
The monetary value has two decimal points (defaulted to “00”) and cannot be less than zero.
This is an optional field. If no Buyer limit is set, funding involving a particular Buyer is limited only by the overall Funder limit.
There is no default value.

d. Maximum receivable amount. The maximum value of any one receivable.
This is a numeric entry field in which the currency is selected via a dropdown and monetary value is typed in.
If the currency selected differs from the currency used in a particular deployment, then the value is converted to the deployment's currency and is updated in real-time.
The monetary value has two decimal points (defaulted to “00”) and cannot be less than zero.
Any receivable above the maximum amount is automatically rejected.
Separate maximum values may be set for invoices and recurring-revenue receivables.
This is an optional field. If there is no maximum receivable amount set for a particular receivable type, funding for receivables of that type is limited only by the overall Funder limit and, where applicable, only the overall Seller and/or Buyer limit.
There is no default value.

Rates

e. Target A-IRR—This is the target annualized internal rate of return (A-IRR) that Administrator wishes to secure, meaning the return that a short-term financing would produce if extended out over an entire year. Note that there are separate selections for invoices and recurring-revenue receivables (and, in the future, for other types of receivables).
This value is entered through a 2-decimal-point percentage entry field, from 0.00% to 99.99%.
The monetary value has two decimal points (defaulted to “00”) and cannot be less than zero nor more than 99.9%.
This field must be completed: it is not optional. The title is followed by: “(Required)”.

There is no default value: the field is blank.

f. Fixed rate?—This field indicates whether the discount charged is fixed or variable (i.e., dependent on the SuRF Score). Note that there are separate selections for invoices and recurring-revenue receivables (and, in the future, for other types of receivables).
There is a numeric-entry field in which a 2-decimal point value may be entered, from 0.00% to 99.99%. A gray “0.00%” is present in the field.
There is no default value.
Above the field are four radio buttons with small text: o No o Per* o Qtly o Mo—“No” is selected by default. Alternatively, dropdowns with the same options (spelled out) can be used. The footnote for “Per*” reads “Per receivable, regardless of term.”
Content can be entered in the field only if “Per*” (per-receivable), “Qtly” (quarterly), or “Mo” (monthly) is selected.
If “No” is selected after a value has been entered, the value disappears and the field returns to the gray 0.00% and is not editable.
If a value is wiped out (rather than typed over), the selector changes from “Per*,” “Qtly,” or “Mo” to “No” and the field is not editable until either “Per*,” “Qtly,” or “Mo” has been selected.
This is an optional field. if “No” is not changed or if “Per*,” “Qtly,” or “Mo” is selected but no value is entered, then no fixed rate is set, and the discount rate for receivables is determined as described in the “Discount Rates & Offers” specs in Appendices C & D.
Note: If a fixed discount rate is selected that conflicts with an already entered maximum APR (see below), then APR changes accordingly. For instance, if an APR of 18.00% has already been selected and a fixed rate of 2.00% per month (24.00% APR) is entered, then the maximum APR field changes to 24.00%.

g. Maximum APR—This is the maximum annual percentage rate, as a percentage of the receivable's value that may be assessed Sellers of receivables. Note that there are separate selections for invoices and recurring-revenue receivables (and, in the future, for other types of receivables).
This value is entered through a 2-decimal-point percentage entry field, from 0.00% to 99.99%.
There is no default value: the field is blank.
This is an optional field. If no value is entered and a fixed rate has not been selected (see above), then no maximum APR is set, and the discount rate is determined as described in the “Discount Rates & Offers” specs in Appendices C & D.
If no value is entered and a fixed rate is subsequently selected, then the maximum APR is automatically set to equal the fixed rate (equal to the entered value if “Ann” is selected and equal to 12× the entered value if “Mo” is selected. (If the fixed value is subsequently eliminated, the Maximum APR remains as it was unless changed.)
Note: If a maximum APR is selected that conflicts with an already entered fixed rate (see above), then the fixed rate changes accordingly, although the selection of “Ann” or “Mo” does not change. For instance, if a fixed rate of 2.00% per month (24.00% APR) has already been selected and an APR of 18.00% is entered, then the fixed rate field changes to 1.50%, although “Mo” remains selected.

h. Advance rate—This is the percentage of the receivable's value that is used as the basis for funding. Note that there are separate selections for invoices and recurring-revenue receivables (and, in the future, for other types of receivables).
This value is entered through a 2-decimal-point percentage entry field, from 0.00% to 99.99%.
For instance, if the receivable amount is $1,000.00 and the advance rate is 90.00%, then the amount that is used as the basis for funding=$1,000.00*90.00%=$900.00. If the discount rate is 5.00%, then the amount of funding provided will be (1−5.00%)*$900.00=$855.00.
The default advance rate is 100.00%. For cases in which the advance rate is less than 100.00%, the Seller repays only the advance rate amount, not the full amount of the invoice.
For invoices only, the advance rate may be transformed into a holdback, with a “0/1” variable to indicate whether a rebate is associated with the withheld funds. (a) In the case of a “0” entry, there is no rebate, and things operate normally, with the Seller needing to repay only the advance rate amount. (b) In the case of a “1” entry, there is a rebate, and the Seller is required to repay the full receivable value, and receives a rebate of the withheld amount less any diminution based on the lateness of the repayment, as described in The Invoice Pricing section.
If a rebate is selected, a “Rebate Expiration” timing field shows up, and Administrator also can select the period (in days) over which the rebate expires if full repayment of the receivables funding is not repaid. The effect of this expiration date is also discussed in The Invoice Pricing section.
This is an optional field. If no value is selected for this field, 100.00% is used as the advance rate, and—for invoices—the default “0/1” indicator is “0.” The default expiration days is 91.

i. Grace periods. The grace period parameter determines whether or not there is an end-of-month lag and a one-month lag between when the monthly payment is billed and when it is due to be paid. Note that there are separate selections for invoices and recurring-revenue receivables (and, in the future, for other types of receivables).
There are two grace-period options: (1) until the end of the current month; and (2) until the end of the following month (i.e., one additional month beyond the end of the current month).
A dropdown contains these options: (1) No grace period; (2) End of this month; and (3) End of next month.
“No grace period” is selected by default.
For both types of grace periods, if selected “1” is output; otherwise, “0” is output (see the “Discount Rates & Offers” specs in Appendices C& D for an explanation of how these outputs are applied).
This is an optional field. If no selection is made, there are no grace periods.
Note: Separate grace periods may be selected for each type of receivable.

j. Assumed # funding events/year. This is a parameter in the calculation of delinquency probabilities.
This figure is entered in a whole-number field, with values ranging from 1 to 100.
The default value is 10.
This is an optional field. If no selection is made, the default value is used.
See the “Discount Rates & Offers” specs in Appendices C & D for an explanation of how this value is used.

Company & Receivable Filters

k. Minimum acceptable SuRF Score (for Sellers and Buyers) and combined SuRF Score (for receivables)—These scores determine the participation of Sellers and Buyers and the acceptability of receivables for financing.
The minimum acceptable SuRF Score for Sellers and Buyers represents the score that these companies must possess in order to participate in Funder deployments (or, in the case of multi-Funder environments, to sell receivables to individual Funders). Sellers that do not possess the required minimum are not allowed to participate on Funders' platforms (or its receivables cannot receive offers from Funders on a multi-Funder platform).
Receivables with a combined score below the minimum—even if the Seller's and/or Buyer's score is above the minimum—or having a Buyer with a score below the minimum cannot be sold on Funders' platforms (or such receivables cannot be given offers from Funders on a multi-Funder platform).
These minimums are entered through individual whole-number (no decimals) entry fields, from 0 to 100.
There are separate fields (and hence separate minimum scores) for Sellers, Buyers, and receivables (i.e., combined SuRF Scores).
This is an optional field. If no values are entered for a particular indicator (Seller, Buyer, or combined), there is no minimum in effect.
There is no default: the three fields are blank.

l. Minimum remaining term for receivables—the minimum period that receivables must possess until their final payment is due in order to qualify for sale within the Administrator platform.
There are separate fields for invoices and recurring-revenue receivables (and other receivables, when added).
The invoices field is denominated in days; the recurring-revenue field is denominated in months.
The fields are blank by default.
These fields cannot be less than zero.
These are optional fields. If no value is entered for a given receivable type, there is no minimum remaining term.

m. Maximum remaining term for receivables—the maximum period that receivables can possess until their final payment is due in order to qualify for sale within the Administrator platform.
There are separate fields for invoices and recurring-revenue receivables (and other receivables, when added).
The invoices field is denominated in days; the recurring-revenue field is denominated in months.
The fields are blank by default.
These fields cannot be less than zero.
In addition, the maximum term must be greater than the minimum term.
These are optional fields. If no value is entered for a given receivable type, there is no maximum remaining term.

n. Bankruptcy experiences. This variable allows Administrator to exclude certain Sellers from participation in its platform according to their bankruptcy experience. There are two fields.
Maximum number of bankruptcies—This field contains a dropdown with numbers between 0 and 10 that allows Administrator to select the maximum number of bankruptcies that a Seller may have above which the Seller will not be allowed participate on the platform. There is no default.
Most recent bankruptcy—This field contains a dropdown with year, month, and date selectors that allow Administrator to select the most recent date for a bankruptcy subsequent to which participation in platform will not be allowed. There is no default.
This is an optional field. If Administrator does not make either or both selections, the respective bankruptcy criteria will not be applied.

o. UCC experiences. This variable allows Administrator to exclude certain Sellers from participation in its platform according to their UCC experience. There are two fields.
Maximum number of UCC reports—This field contains a dropdown with numbers between 0 and 10 that allows Administrator to select the maximum number of UCC reports that a Seller may have above which the Seller will not be allowed participate on the platform. There is no default.
Most recent UCC report—This field contains a dropdown with year, month, and date selectors that allow Administrator to select the most recent date for a UCC report subsequent to which participation in platform will not be allowed. There is no default.
This is an optional field. If Administrator does not make either or both selections, the respective UCC criteria will not be applied.
If Administrator has not authorized UCC checks, these criteria will not be applied, even if values are selected.

p. Minimum acceptable bond rating for Sellers and/or Buyers—For companies that have bond ratings, this value determines whether or not receivables whose companies have bond ratings can be approved for financing.
The minimum acceptable bond rating for Sellers and Buyers represents the bond rating that these companies must possess in order for their receivables to be sold within the Administrator platform or to receive an offer from Funders within multi-Funder environments.
Receivables on which a Seller and/or a Buyer with a bond rating has a bond rating that is below the minimum cannot be sold on Funders' platforms (or such receivables cannot be given offers from Funders on a multi-Funder platform).
These minimums are selected by choosing a bond rating from a dropdown list with S&P bond ratings. The chosen bond rating serves as the minimum.
There are separate dropdowns (and hence separate minimum bond ratings) for Sellers and Buyers. The contents of the dropdown list (in order) are: AAA (Aaa), AA+(Aa1), AA (Aa2), AA−(Aa3), A+(A1), A (A2), A−(A3), BBB+(Baa1), BBB (Baa2), BBB−(Baa3), BB (Ba), B (B), CCC (Caa), CC (Ca), and C (C).
These are optional selections. If no values are selected for Sellers and/or Buyers, there is no minimum in effect for those companies.
There are no defaults: each dropdown says simply, “Select.”

q. Acceptable industries for funding, which allows Administrator to exclude certain industries from funding throughout the Administrator platform.
Selections are made from a checkbox list from Administrator's industry taxonomy.
“All Industries” is checked by default.
Administrator can select as many individual or as few industries as desired.
Checking an individual industry unchecks “All Industries.”
Unchecking everything or clicking “Clear All” re-checks “All Industries.”
Only those industries that are selected are eligible for funding by Administrator will appear in Funders' industry lists.
Only Sellers in industries that Administrator selects as eligible for funding will be able to sell receivables within the Administrator platform—and hence within Funders' funding deployments)—or, in the case of Funders in multi-Funder funding environments, be able to have their receivables considered for funding.
This is an optional field. If no selection is made, “All Industries” will govern.
This section is grayed-out for now until industries are defined.

r. Acceptable geographies for funding, which allows Administrator to exclude certain geographies from funding throughout the Administrator platform.
Selections are made from a checkbox list from Administrator's geography taxonomy.
“All Geographies” is checked by default.
Administrator can select as many or as few individual geographies as desired.
Checking an individual geography unchecks “All Geographies.”
Unchecking everything or clicking “Clear All” re-checks “All Geographies.”
Only those geographies that are selected are eligible for funding by Administrator will appear in Funders' geography lists.
Only Sellers in geographies that Administrator selects as eligible for funding will be able to sell receivables within the Administrator platform—and hence within Funders' funding environments)—or, in the case of Funders in multi-Funder funding environments, be able to have their receivables considered for funding.
This is an optional field. If no selection is made, “All Geographies” will govern.
This section is grayed-out for now until geographies are defined.

s. Minimum acceptable sustainability score, which allows Administrator to include within its platform only those companies that have a certain minimum sustainability score.
Administrator selects whether a sustainability score is required, with the field labeled: “Sustainability score required?” The default value is “No.” Clicking it changes the field to “Yes.” Clicking it again changes the field back to “No.”
Administrator also enters the minimum sustainability score in a whole-number field accepting values of 0 to 100.
The selection field is blank by default.
The minimum sustainability floor selected by Administrator sets a floor for companies that will be eligible candidates for funding throughout the Administrator platform. For instance, if Administrator selects “50” as the minimum sustainability score, then no Funder will be able to select a minimum sustainability score below 50.
If Administrator has indicated that a sustainability score is required but has not established a minimum, then Sellers must possess a sustainability score in order to participate in any platform throughout the Administrator environment, although the Seller need not possess any minimum sustainability score.
This is an optional field. If no selection is made, there will be no sustainability-score restrictions.
This section is grayed-out for now until sustainability scores are defined.

Fees

t. Target Administrator fee (as a percentage of the receivable's value).
The administrative fee received by Administrator.
It is entered through a 2-decimal-point percentage entry field, from 0.00% to 99.99%.
This is an optional field. If no value is entered, Administrator receives no money from any funding environment except those in which Administrator or an Administrator-managed SPV is the Funder and a target Administrator fee is set at the Funder level.
There is no default value.

u. Insurance fee?—This “Yes” or “No” field indicates whether Administrator wishes to enable receivables-insurance purchases within its platform. Note that separate selections are made for invoices and recurring-revenue receivables (and, in the future, for other types of receivables).
The first field is “Enable insurance?” The default value is “No.” Clicking it changes the field to “Yes.” Clicking it again changes the field back to “No.”
If Administrator selects “Yes,” the Administrator insurance parameters in the sections following this one are used to calculate the insurance fee for each given receivable.
Other than the “Enable Insurance options, the remaining insurance fields are grayed out until and unless “Yes” is selected. If so, then everything is made visible and selectable except for the table described below.
Administrator first selects the options (with radio buttons): (1) “Require for all invoices” or “Require for all recurring contracts”; and (2) Require based on SuRF Score.
The first option in each case (invoices or recurring-revenue receivables) is selected by default. Clicking the second option makes the table below active and selectable for the selected type. Rechecking the first option grays the table out again but leaves any entered values in place.

For Combined SuRF Scores:* Do the Following:

| From | To | |
|---|---|---|
| 00 | 100 | Fund without requiring insurance |
| 00 | 00 | Fund only if insurance is approved |
| 0 | 00 | Do not fund |

*(Seller SuRF Score * Buyer SuRF Score)/100

If Administrator has selected the second option (“Require based on SuRF Score”) for either or both receivable types, Administrator must fill in all of the grayed-out numbers with whole numbers. No lower-level number may be higher than a higher-level number.
There also can be no separation between succeeding numbers. For instance, if the upper left number is 90, then the middle-right number must be 89.
A given number (other than 100) includes all decimals above that number. For instance, 90 includes 90.01, 90.1, 90.2, all the way up to 90.9999999 . . .
If two numbers in a row are the same, then there are no receivables in that row, and the next upper-left number is automatically the same (except for the top row). For instance, if the two numbers in the middle row are 80, then the upper-left number must be 80 as well.
This is an optional field. If no values are selected or if Administrator does not enable insurance, no receivables insurance is provided within the Administrator platform.
Default values are indicated above.

v. Target insurance fee (as a percentage of the receivable's value). Note that separate selections are made for invoices and recurring-revenue receivables (and, in the future, for other types of receivables).
This is the fee assessed to pay for receivables insurance, entered through a 2-decimal-point percentage entry field, from 0.00% to 9.99%.
If insurance is not available for the class of receivables in question, then the target insurance fee for that class of receivables will be 0.00%, regardless of Administrator's target insurance fee or the Funder's insurance selection.
If insurance is available for the class of receivables in question, then the assigned fee applies.
This is an optional field. If no value is entered, then no insurance is provided throughout the Administrator universe.
The default value is 0.00%.
If receivables insurance is not selected (field f above), then this selection field is grayed-out.

w. Insurance threshold. Note that separate selections are made for invoices and recurring-revenue receivables (and, in the future, for other types of receivables).
The lowest receivable value against which insurance fees are assessed.
It is entered through a 7-digit plus 2-decimal-point monetary value entry field in which the currency is selected via a dropdown and monetary value is typed in.
If the currency selected differs from the currency used in a particular deployment, then the value is converted to the deployment's currency and is updated in real-time.
This is an optional field. If no value is entered, then there is no insurance threshold (i.e., all receivables, regardless of value, are assessed an insurance fee if insurance is being offered.)
The default value is $0.00.
If receivables insurance is not selected (field f above), then this selection field is grayed-out.

x. Maximum insurance fee. Note that separate selections are made for invoices and recurring-revenue receivables (and, in the future, for other types of receivables).
The maximum per-receivable insurance fee that may be assessed.
It is entered through a 7-digit plus 2-decimal-point monetary value entry field in which the currency is selected via a dropdown and monetary value is typed in.
If the currency selected differs from the currency used in a particular deployment, then the value is converted to the deployment's currency and is updated in real-time.
This is an optional field. If no value is entered, then there is no maximum insurance fee.
There is default value.
If receivables insurance is not selected (field f above), then this selection field is grayed-out.

y. UCC fee?—This “Yes” or “No” field indicates whether Administrator wishes to conduct a UCC search for receivables on its platform. The UCC sections are similar but not identical to the insurance sections. Note that separate selections are made for invoices and recurring-revenue receivables (and, in the future, for other types of receivables).
The first field is “Enable UCC Checks?” The default value is “No.” Clicking it changes the field to “Yes.” Clicking it again changes the field back to “No.”
If Administrator selects “Yes,” the Administrator UCC parameters in the sections following this one are used to calculate the UCC fee for each given receivable.
Other than the “Enable UCC options, the remaining UCC fields are grayed out until and unless “Yes” is selected. If so, then everything is made visible and selectable except for the table described below.
The second field is labeled “Conduct UCC checks . . . ” with a dropdown with the choices “Every time,” “Every week,” “Every month,” “Every quarter,” and “Every year.” The default value is

“Every month.” (UCC searches are conducted only on the Buyer company, and so this selection applies to the appearance of individual Buyers. For instance, if the Buyer is Amazon, the selection “Conduct UCC searches every month” would indicate that, when a UCC search is conducted on Amazon, another UCC search does not have to be conducted on Amazon for another month, no matter how many receivables during that period have Amazon as the Buyer.) This field is grayed-out unless the “Enable UCC checks?” selection is set to “Yes.”
Administrator next selects the options (with radio buttons): (1) “Require for all invoices” or “Require for all recurring contracts”; and (2) Require based on SuRF Score.
The first option in each case (invoices or recurring-revenue receivables) is selected by default. Clicking the second option makes the table below active and selectable for the selected type. Rechecking the first option grays the table out again but leaves any entered values in place.

For Combined SuRF Scores:* Do the Following:

| From | To | |
|---|---|---|
| 00 | 100 | Fund without requiring UCC checks |
| 00 | 00 | Fund only with satisfactory UCC checks |
| 0 | 00 | Do not fund |

*(Seller SuRF Score * Buyer SuRF Score)/100

If Administrator has selected the second option (“Require based on SuRF Score”) for either or both receivable types, Administrator must fill in all of the grayed-out numbers with whole numbers. No lower-level number may be higher than a higher-level number.
There also can be no separation between succeeding numbers. For instance, if the upper left number is 90, then the middle-right number must be 89.
A given number (other than 100) includes all decimals above that number. For instance, 90 includes 90.01, 90.1, 90.2, all the way up to 90.9999999 . . .
If two numbers in a row are the same, then there are no receivables in that row, and the next upper-left number is automatically the same (except for the top row). For instance, if the two numbers in the middle row are 80, then the upper-left number must be 80 as well.
This is an optional field. If no values are selected or if Administrator does not enable UCC checks, no UCC checks are provided within the Administrator platform.
Default values are indicated above.

z. Target UCC fee (as a percentage of the receivable's value). Note that separate selections are made for invoices and recurring-revenue receivables (and, in the future, for other types of receivables).
This is the fee assessed to pay for UCC searches, entered through a 2-decimal-point percentage entry field, from 0.00% to 9.99%.
If UCC searches are not enabled for the class of receivables in question, then the target UCC fee for that class of receivables will be 0.00%, regardless of Administrator's target UCC fee or the Funder's UCC selection.
If UCC searches are enabled for the class of receivables in question, then the assigned fee applies.
This is an optional field. If no value is entered, then no UCC searches are provided throughout the Administrator universe.
The default value is 0.00%.
If UCC searches are not enabled (field j above), then this selection field is grayed-out.

aa. UCC threshold. Note that separate selections are made for invoices and recurring-revenue receivables (and, in the future, for other types of receivables).
The lowest receivable value against which UCC fees are assessed.
It is entered through a 7-digit plus 2-decimal-point monetary value entry field in which the currency is selected via a dropdown and monetary value is typed in.
If the currency selected differs from the currency used in a particular deployment, then the value is converted to the deployment's currency and is updated in real-time.
This is an optional field. If no value is entered, then there is no UCC threshold (i.e., all receivables, regardless of value, are assessed a UCC fee if UCC searches are enabled.)
The default value is $0.00.
If UCC searches are not enabled (field j above), then this selection field is grayed-out.

bb. Maximum UCC fee. Note that separate selections are made for invoices and recurring-revenue receivables (and, in the future, for other types of receivables).
The maximum per-receivable UCC fee that may be assessed.
It is entered through a 7-digit plus 2-decimal-point monetary value entry field in which the currency is selected via a dropdown and monetary value is typed in.
If the currency selected differs from the currency used in a particular deployment, then the value is converted to the deployment's currency and is updated in real-time.
This is an optional field. If no value is entered, then there is no maximum UCC fee.
There is default value.
If UCC searches are not enabled (field j above), then this selection field is grayed-out.

cc. Fee spread. This is the number of days over which the above Administrator, insurance, and UCC fees may be spread regardless of the calculated fees. Note that separate selections are made for invoices and recurring-revenue receivables (and, in the future, for other types of receivables).
For instance, if a receivable has a 30-day remaining term and the fee spread is 60, then the total fees would be spread out over 60 days despite the fact that the invoice had only a 30-day term, and the Seller would be charged only the first 30 days' worth of fees.
By way of example, if fees in the situation just described totaled $100.00, then the amount assessed a 30-day invoice would be $100.00*(30/60)=$100.00*0.5=$50.00.
These are optional fields. If no selections are made, there is no fee spread.
There is no default value: the fields are blank.

dd. Broker's fee. This is fee charged as a percentage of a receivable's value for a broker to bring receivables to the Funder. There are no separate fields for invoices and recurring-revenue receivables.
There is a “Yes”/“No” field. “No” is checked by default.
There is also a numeric-entry field, representing the level of the fee, entered through a 2-decimal-point percentage entry field, from 0.00% to 99.99%. The field includes a gray “0.00%” entry by default. It cannot be edited as long as “No” is checked.
If “Yes” is checked in the “Yes”/“No” field, then the numeric-entry field becomes editable.
If “No” is checked again, any entered values remain, but become gray and non-editable.
This is an optional field. If no selection is made, the default values remain, and there is no broker's fee.
Note: Even if a broker's fee has been chosen by the Funder, not all receivables may come by way of a broker. If a receivable comes by way of a broker, a “1” is passed to the calculator (Cell G14); if a receivable does not come by way of a broker, a “0” is passed to the calculator (Cell G14).

Note: Changes in Administrator parameters apply to all future receivables uploads from the time of the change forward.

Returning to FIG. 1, at step 102 a plurality of network-client parameters corresponding to a network-client registered with the tokenized transfer network are determined. In the receivable based funding context, a plurality of funder parameters are determined corresponding to a funder registered with the platform.

The funder parameters can be determined in a variety of ways. For example, the funder parameters can be set to some default value, input or modified via a web portal or other interface, and/or be automatically determined based upon some algorithm or process running on the funder system, the platform, or a system connected to the platform or the funder system on the network. Funder parameters can be linked to specific sellers or buyers or receivables.

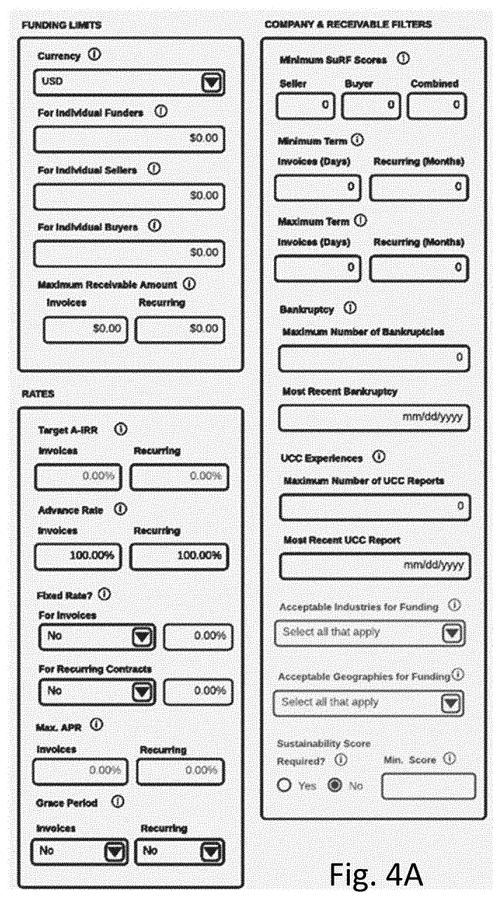

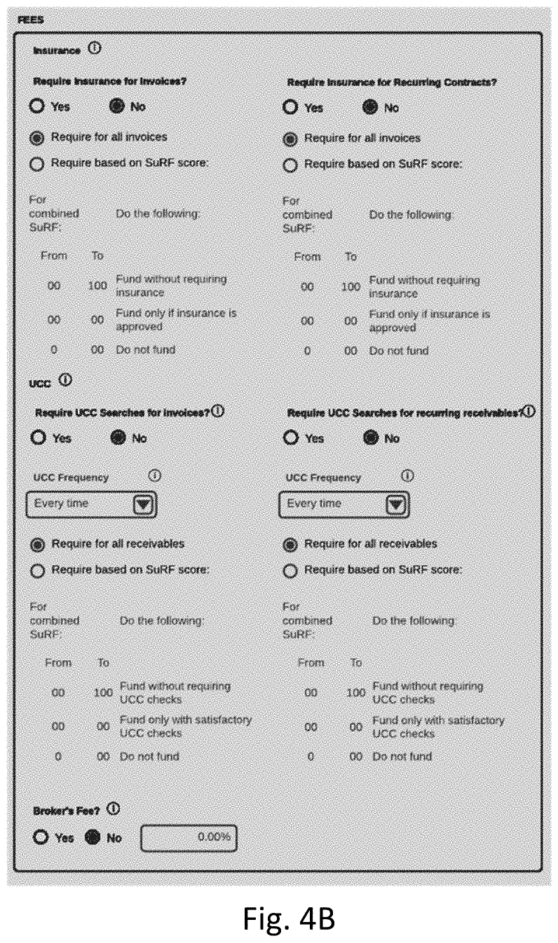

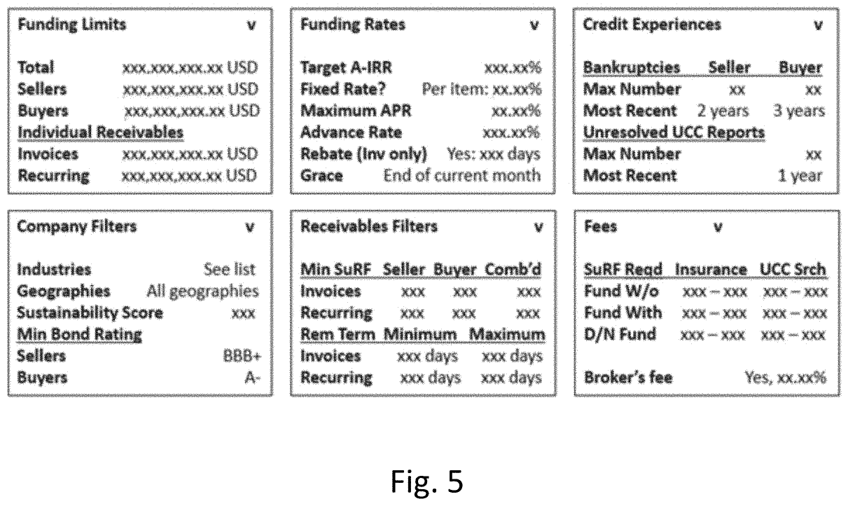

FIGS. 4A-4B illustrate interface screens for inputting funder parameters according to an exemplary embodiment. FIG. 5 illustrates a setting page of a Funder portal that shows several Funder parameters according to an exemplary embodiment. Each of these funder parameters, and other funder parameters, are explained below.

Network Client/Funder Parameters

Funders for each deployment (including Administrator for its self-funding efforts and its SPVs) set 21 overall funding parameters that apply to their specific deployment or funding environment. Funders participating in multi-Funder environments, such as multi-Funder facilities and the secondary market, also set these parameters. In cases in which Administrator has set universal parameters (see the “Administrator Parameters” spec in The Administrator Parameters section), the Administrator parameters either serve as defaults for or as limits on the Funder parameters, as noted below.

Funding Limits

a. Funder's overall funding limit—The maximum amount of funding that the Funder is willing to have out (i.e., its total financial exposure) throughout its entire deployment or a particular funding environment (e.g., a multi-Funder facility or the secondary market) at any one time.
This is a numeric entry field in which the currency is selected via a dropdown and monetary value is typed in.
If the currency selected differs from the currency used in a particular transaction, then the value is converted to the transaction's currency and is updated in real-time.
The monetary value has two decimal points (defaulted to “00”) and cannot be less than zero.
The default value is the value that Administrator has set for this parameter, if one has been set; otherwise the field is blank.
This field is required. It must be completed before the deployment can operate or the Funder can participate in a particular funding environment.

b. Funding limits for individual Sellers— The maximum amount of funding that the Funder is willing to have out for each individual Seller out (i.e., its Seller-specific financial exposure) at any one time.
This is a numeric entry field in which the currency is selected via a dropdown and monetary values are typed in.
If the currency selected differs from the currency used by a particular Seller, then the value is converted to the transaction's currency and is updated in real-time.
The monetary value has two decimal points (defaulted to “00”) and cannot be less than zero.
The default value is the value that Administrator has set for this parameter, if one has been set; otherwise the field is blank.
If Administrator has set a value for this parameter, the Funder can override it or else clear the field.
This is an optional field. If no Seller limit is set, funding for a particular Seller is limited only by the overall Funder limit.

c. Funding limits for individual Buyers—The maximum amount of funding that the Funder is willing to have out (i.e., its Buyer-specific financial exposure) for each individual Buyer at any one time.
This is a numeric entry field in which the currency is selected via a dropdown and monetary values are typed in.
If the currency selected differs from the currency used by a particular Seller, then the value is converted to the transaction's currency and is updated in real-time.
The monetary value has two decimal points (defaulted to “00”) and cannot be less than zero.
The default value is the value that Administrator has set for this parameter, if one has been set; otherwise the field is blank.
If Administrator has set a value for this parameter, the Funder can override it or else clear the field.

This is an optional field. If no Seller limit is set, funding for a particular Seller is limited only by the overall Funder limit.

d. Maximum receivable amount—The maximum value of any one receivable.
This is a numeric entry field in which the currency is selected via a dropdown and monetary value is typed in.
If the currency selected differs from the currency used in a particular transaction, then the value is converted to the deployment's currency and is updated in real-time.
The monetary value has two decimal points (defaulted to “00”) and cannot be less than zero.
Any receivable above the maximum amount are automatically rejected.
Separate values may be set for invoices and recurring-revenue receivables.
The default values are the values that Administrator has set for this parameter, if they have been set; otherwise one or both of the fields are blank.
This is an optional field. If there is no maximum receivable amount set for a particular receivable type, funding for receivables of that type is limited only by the overall Funder limit and, where applicable, only the overall Seller and/or Buyer limit.

Rates

e. Target A-IRR—This is the target annualized internal rate of return (A-IRR) that the Funder wishes to secure, meaning the return that a short-term financing would produce if extended out over an entire year. Note that there are separate selections for invoices and recurring-revenue receivables (and, in the future, for other types of receivables)
This value is entered through a 2-decimal-point percentage entry field, from 0.00% to 99.99%.
The monetary value has two decimal points (defaulted to “00”) and cannot be less than zero nor more than 99.9%.
The default target A-IRR is the value that Administrator has chosen. The Funder can either accept the Administrator value or insert its own.
However, if the Funder clears the Administrator value, it must add one of its own. This field is required and must be completed before the screen can be closed and the deployment or funding environment can operate. The title is followed by “Required.”

f. Fixed rate?—This field indicates whether the discount charged is fixed or variable (i.e., dependent on the SuRF Score). Note that there are separate selections for invoices and recurring-revenue receivables (and, in the future, for other types of receivables).
There is a numeric-entry field in which a 2-decimal point value may be entered, from 0.00% to 99.99%. A gray “0.00%” is present in the field, unless Administrator has entered a value, in which case that value shows up (in black).
Above the field are four radio buttons with small text: o No o Per* o Qtly o Mo—“No” is selected by default. Alternatively, dropdowns with the same options (spelled out) can be used. The footnote for “Per*” reads “Per receivable, regardless of term.”
If Administrator has not made a selection for this field, then “No” is the default value. However, if Administrator has selected “Per*,” “Qtly,” or “Mo,” then that is the default, and their chosen value is the default value—although both can be changed.
Content can be entered in the field only if “Per*” (per-receivable), “Qtly” (quarterly), or “Mo” (monthly) is selected.
If “No” is selected after a value has been entered, the value disappears and the field returns to a gray 0.00% and is not editable.
If a value is wiped out (rather than typed over), the selector changes from “Per*,” “Qtly,” or “Mo” to “No” and the field is not editable until either “Per*,” “Qtly,” or “Mo” has been selected.
This is an optional field. if “No” is not changed or if “Per*,” “Qtly,” or “Mo” is selected but no value is entered, then no fixed rate is set, and the discount rate for receivables is determined as described in the “Discount Rates & Offers” specs in Appendices C & D.
Note: If a fixed discount rate is selected that conflicts with an already entered maximum APR (see below), then APR changes accordingly. For instance, if an APR of 18.00% has already been selected and a fixed rate of 2.00% per month (24.00% APR) is entered, then the maximum APR field changes to 24.00%.

g. Maximum APR—This is the maximum annual percentage rate, as a percentage of the receivable's value that may be assessed Sellers of receivables. Note that there are separate selections for invoices and recurring-revenue receivables (and, in the future, for other types of receivables).
This value is entered through a 2-decimal-point percentage entry field, from 0.00% to 99.99%.
The default value is the value that Administrator has entered for this parameter, if any. If Administrator has not entered a value, the field is blank.
This is an optional field. If no value is entered (or the Administrator value is cleared and a fixed rate has not been selected (see above), then no maximum APR is set, and the discount rate is determined as described in the “Discount Rates & Offers” specs in Appendices C & D.
If no value is entered and a fixed rate is subsequently selected, then the maximum APR is automatically set to equal the fixed rate (equal to the entered value if “Ann” is selected and equal to 12× the entered value if “Mo” is selected. (If the fixed value is subsequently eliminated, the Maximum APR remains as it was unless changed.)
Note: If a maximum APR is selected that conflicts with an already entered fixed rate (see above), then the fixed rate changes accordingly, although the selection of “Ann” or “Mo” does not change. For instance, if a fixed rate of 2.00% per month (24.00% APR) has already been selected and an APR of 18.00% is entered, then the fixed rate field changes to 1.50%, although “Mo” remains selected.
h. Advance rate—This is the percentage of the receivable's value that is used as the basis for funding. Note that there are separate selections for invoices and recurring-revenue receivables (and, in the future, for other types of receivables).
This value is entered through a 2-decimal-point percentage entry field, from 0.00% to 99.99%.
For instance, if the receivable amount is $1,000.00 and the advance rate is 90.00%, then the amount that is used as the basis for funding=$1,000.00*90.00%=$900.00. If the discount rate is 5.00%, then the amount of funding provided will be (1−5.00%)*$900.00=$855.00.
The default advance rate is the value that Administrator has chosen. If Administrator has not chosen a value, then the default rate is 100.00%. For cases in which the advance rate is less than 100.00%, the Seller repays only the advance rate amount, not the full amount of the invoice.
For invoices only, the advance rate may be transformed into a holdback, with a “0/1” variable to indicate whether a rebate is associated with the withheld funds. (a) In the case of a “0” entry, there is no rebate, and things operate normally, with the Seller needing to repay only the advance rate amount. (b) In the case of a “1” entry, there is a rebate, and the Seller is required to repay the full receivable value, and receives a rebate of the withheld amount less any diminution based on the lateness of the repayment, as described in The Invoice Pricing section.
If a rebate is selected, a “Rebate Expiration” timing field shows up, and the Funder also can select the period (in days) over which the rebate expires if full repayment of the receivables funding is not repaid. The effect of this expiration date is also discussed in The Invoice Pricing section.
This is an optional field. If no value is selected for this field, 100.00% is used as the advance rate. For invoices. The default “0/1” indicator is whatever Administrator has selected; if Administrator hasn't selected a “0/1” indicator, then the default for Funders is “0.” The default expiration days is whatever Administrator has selected; if Administrator has not made a selection, then the default for Funders is 91 days.

i. Grace periods. The grace period parameter determines whether or not there is an end-of-month lag and a one-month lag between when the monthly payment is billed and when it is due to be paid. Note that there are separate selections for invoices and recurring-revenue receivables (and, in the future, for other types of receivables).
There are two grace-period options: (1) until the end of the current month; and (2) until the end of the following month (i.e., one additional month beyond the end of the current month).
A dropdown contains these options: (1) No grace period; (2) End of this month; and (3) End of next month.
“No grace period” is selected by default.
For both types of grace periods, if selected “1” is output; otherwise, “0” is output (see the “Discount Rates & Offers” specs in Appendices C & D for an explanation of how these outputs are applied).
This is an optional field. If no selections are made by the Funder, then the Administrator selections, if any, govern. If no selections are made by the Funder nor are there any Administrator selections, then there are no grace periods.
Note: Separate grace periods may be selected for each type of receivable.

Company & Receivable Filters

j. Minimum acceptable SuRF Score (for Sellers and Buyers) and combined SuRF Score (for receivables)—These scores determine the participation of Sellers and Buyers and the acceptability of receivables for financing.
The minimum acceptable SuRF Score for Sellers and Buyers represents the score that these companies must possess in order to participate in the Funder's deployment (or, in the case of multi-Funder environments, to sell receivables to the given Funder). Sellers that do not possess the required minimum are not allowed to participate on the Funder” platform (or its receivables cannot receive offers from the given Funder on a multi-Funder platform).
Receivables with a combined score below the minimum—even if the Seller's and/or Buyer's score is above the minimum—or having a Buyer with a score below the minimum cannot be sold on the Funder's platform (or such receivables cannot be given offers from the respective Funder on a multi-Funder platform).
These minimums are entered through individual whole-number (no decimals) entry fields, from 0 to 100.
There are separate fields (and hence separate minimum scores) for Sellers, Buyers, and receivables (i.e., combined SuRF Scores).
The values chosen by Administrator for the respective fields serve as the Funder's defaults. If Administrator did not select a value, then there is no default, and the respective field(s) is/are blank.
This is an optional field. If no values are entered for a particular indicator (Seller, Buyer, or combined), there is no minimum in effect.

k. Minimum remaining term for receivables—the minimum period that receivables must possess until their final payment is due in order to qualify for sale within the Funder's deployment (or, in the case of multi-Funder environments, to sell receivables to the given Funder).
There are separate fields for invoices and recurring-revenue receivables (and other receivables, when added).
The fields are blank by default.
These fields cannot be less than zero.
These are optional fields. If no value is entered by the Funder for a given receivable type, then the Administrator value, if any, governs; if no value is entered by the Funder and there is no Administrator value, then there is no minimum remaining term.

l. Maximum remaining term for receivables—the maximum period that receivables can possess until their final payment is due in order to qualify for sale within the Funder's deployment (or, in the case of multi-Funder environments, to sell receivables to the given Funder).
There are separate fields for invoices and recurring-revenue receivables (and other receivables, when added).
The fields are blank by default.
These fields cannot be less than zero.
In addition, the maximum term must be greater than the minimum term.
These are optional fields. If no value is entered by the Funder for a given receivable type, then the Administrator value, if any, governs; if no value is entered by the Funder and there is no Administrator value, then there is no maximum remaining term.

m. Bankruptcy experiences. This variable allows Funders to exclude certain Sellers from participation in its platform according to their bankruptcy experience (or prevents receivables from being considered by the respective Funder in multi-Funder environments). There are two fields.
Maximum number of bankruptcies—This field contains a dropdown with numbers between 0 and 10 that allows the Funder to select the maximum number of bankruptcies that a Seller may have above which the Seller will not be allowed participate in its deployment or to have its receivables considered for funding by the respective Funder in multi-Funder environment. If Administrator has made a selection, then its selection is the default. Otherwise, if Administrator has not made a selection, there is no default.
Most recent bankruptcy—This field contains a dropdown with year, month, and date selectors that allow the Funder to select the most recent date for a bankruptcy subsequent to which participation in its deployment will not be allowed or its receivables will not be considered for funding by the respective Funder in multi-Funder environments. If Administrator has made a selection, then its selection is the default. Otherwise, if Administrator has not made a selection, there is no default.
This is an optional field. If the Funder does not make either or both selections (and if Administrator also has not done so), then the respective bankruptcy criteria will not be applied.

n. UCC experiences. This variable allows the Funder to exclude certain Sellers from participation in its platform according to their UCC experience (or prevents receivables from being considered by the respective Funder in multi-Funder environments). There are two fields.
Maximum number of UCC reports—This field contains a dropdown with numbers between 0 and 10 that allows the Funder to select the maximum number of UCC reports that a Seller may have above which the Seller will not be allowed participate in its deployment or to have its receivables considered for funding by the respective Funder in multi-Funder environment. If Administrator has made a selection, then its selection is the default. Otherwise, if Administrator has not made a selection, there is no default.
Most recent UCC report—This field contains a dropdown with year, month, and date selectors that allow the Funder to select the most recent date for a UCC report subsequent to which participation in its deployment will not be allowed or its receivables will not be considered for funding by the respective Funder in multi-Funder environments. If Administrator has made a selection, then its selection is the default. Otherwise, if Administrator has not made a selection, there is no default.
This is an optional field. If the Funder does not make either or both selections (and if Administrator also has not done so), then the respective UCC criteria will not be applied.
If the Funder has not authorized UCC checks (or if Administrator has not done so), these criteria will not be applied, even if values are selected.

o. Minimum acceptable bond rating for Sellers and/or Buyers—For companies that have bond ratings, this value determines whether or not receivables whose companies have bond ratings can be approved for financing.
The minimum acceptable bond rating for Sellers and Buyers represents the bond rating that these companies must possess in order for their receivables to be sold within the Administrator platform or to receive an offer from Funders within multi-Funder environments.
Receivables on which a Seller and/or a Buyer with a bond rating has a bond rating that is below the minimum cannot be sold on Funders' platforms (or such receivables cannot be given offers from Funders on a multi-Funder platform).
These minimums are selected by choosing a bond rating from a dropdown list with S&P bond ratings. The chosen bond rating serves as the minimum.
There are separate dropdowns (and hence separate minimum bond ratings) for Sellers and Buyers. The contents of the dropdown list (in order) are: AAA (Aaa), AA+(Aa1), AA (Aa2), AA−(Aa3), A+(A1), A (A2), A−(A3), BBB+(Baa1), BBB (Baa2), BBB−(Baa3), BB (Ba), B (B), CCC (Caa), CC (Ca), and C (C).
These are optional selections. If no values are selected for Sellers and/or Buyers, there is no minimum in effect for those companies.
The defaults are whatever Administrator has selected, although the Funder can change the selection. In cases in which Administrator has not selected a value, the dropdown says simply, “Select.”

p. Acceptable industries for funding, which allows the Funder to exclude certain industries from funding throughout its deployment (or, in the case of Funders in multi-Funder funding environments, exclude from being considered for offers).
Selections are made from a checkbox list from Administrator's industry taxonomy.
“All Industries” is checked by default.
The Funder can select as many or as few individual industries as desired.
Checking an individual industry unchecks “All Industries.”
Unchecking everything or clicking “Clear All” re-checks “All Industries.”
Only those industries that are selected are eligible for funding by Administrator appear in other Funders' industry lists. Hence, “All Industries” includes only those industries that Administrator has chosen as acceptable.
Only Sellers in industries that the Funder subsequently selects as eligible for funding will be able to sell receivables within the Funder's funding deployment—or, in the case of Funders in multi-Funder funding environments, be able to have their receivables considered for funding.
This is an optional field. If no selection is made, “All Industries” will govern.
This section is grayed-out for now until industries are defined.

q. Acceptable geographies for funding, which allows the Funder to exclude certain geographies from funding throughout its deployment (or, in the case of Funders in multi-Funder funding environments exclude from being considered for offers).
Selections are made from a checkbox list from Administrator's geography taxonomy.
“All Geographies” is checked by default.
The Funder can select as many or as few individual geographies as desired.
Checking an individual geography unchecks “All Geographies.”
Unchecking everything or clicking “Clear All” re-checks “All Geographies.”
Only those geographies that are selected are eligible for funding by Administrator appear in other Funders' geography lists. Hence, “All Geographies” includes only those geographies that Administrator has chosen as acceptable.
Only Sellers in geographies that the Funder subsequently selects as eligible for funding will be able to sell receivables within the Funder's funding deployment— or, in the case of Funders in multi-Funder funding environments, be able to have their receivables considered for funding.
This is an optional field. If no selection is made, “All Geographies” will govern.
This section is grayed-out for now until geographies are defined.

r. Minimum acceptable sustainability score, which allows the Funder to include in its deployment only those companies that have a certain minimum sustainability score (or, in the case of Funders in multi-Funder funding environments exclude from being considered for offers).
The Funder selects whether a sustainability score is required, with the field labeled: “Sustainability score required?” The default value is the value selected by Administrator. Clicking the value changes the field from “Yes” to “No” and vice versa.
The Funder also enters the minimum sustainability score in a whole-number field accepting values of the Administrator minimum to 100.
If Administrator has not selected a minimum, then the range is 0 to 100.
The selection field is populated by the Administrator minimum; if Administrator has not selected a minimum, then the selection field is blank.
The minimum sustainability floor selected by Administrator sets a floor for companies that will be eligible candidates for funding throughout the Administrator platform. For instance, if Administrator selects “50” as the minimum sustainability score, then no Funder will be able to select a minimum sustainability score below 50.
Only Sellers possessing a sustainability score at or above the Funder's selected minimum sustainability score will be able to participate in the Funder's deployment (or, in the case of Funders in multi-Funder funding environments, be able to have their receivables considered for funding).
If a Seller does not possess a sustainability score and the Funder (or the Administrator default) indicates that a sustainability score is required—whether or not a minimum score has been selected—then the Seller cannot participate in the Administrator platform or receive offers from the Funder in multi-Funder environments.
This is an optional field. If no selections are made by either Administrator or the Funder, there will be no sustainability-score restrictions. If no selections are made by the Funder but Administrator has made selections, then the Administrator selections will govern.
This section is grayed-out for now until sustainability scores are defined.

Fees

s. Insurance fee?—This “Yes” or “No” field indicates whether the Funder wishes to purchase insurance for the receivables on its platform or within a funding environment in which it is participating. Note that separate selections are made for invoices and recurring-revenue receivables (and, in the future, for other types of receivables).
The first field is “Enable insurance?” The default value is “No.” Clicking it changes the field to “Yes.” Clicking it again changes the field back to “No.”
If the Funder selects “Yes,” the Funder's insurance parameters in the sections following this one are used to calculate the insurance fee for each given receivable.
Other than the “Enable Insurance options, the remaining insurance fields are grayed out until and unless “Yes” is selected. If so, then everything is made visible and selectable except for the table described below.
The Funder first selects the options (with radio buttons): (1) “Require for all invoices” or “Require for all recurring contracts”; and (2) Require based on SuRF Score.
The choice made by Administrator in each case (invoices or recurring-revenue receivables) is selected by default.
If Administrator has selected the first option for either or both of the receivable types, then if the Funder clicks the second option, the table below becomes active and selectable for that type. Rechecking the first option grays the table out again but leaves any entered values in place.
If Administrator has selected the second option (“Require based on SuRF Score”) for either or both of the receivable types, then the table is already active and selectable for that type. Again, if the Funder then checks the first option, it grays out the table for the selected type.

For Combined SuRF Scores:* Do the Following:

| From | To | |
|---|---|---|
| 00 | 100 | Fund without requiring insurance |
| 00 | 00 | Fund only if insurance is approved |
| 0 | 00 | Do not fund |

*(Seller SuRF Score * Buyer SuRF Score)/100

The grayed-out whole numbers in the table above appear in regular type to the Funder and reflect the Administrator defaults, which the Funder can change. No lower-level number may be higher than a higher-level number.
There also can be no separation between succeeding numbers. For instance, if the upper left number is 90, then the middle-right number must be 89.
A given number (other than 100) includes all decimals above that number. For instance, 90 includes 90.01, 90.1, 90.2, all the way up to 90.9999999 . . .
If two numbers in a row are the same, then there are no receivables in that row, and the next upper-left number is automatically the same (except for the top row). For instance, if the two numbers in the middle row are 80, then the upper-left number must be 80 as well.
If Administrator has enabled insurance and the Funder has as well, receivables in any category of the table (or all categories) in which insurance is required that do not qualify for insurance cannot be funded or receive offers.
This is an optional field. If the Funder does not affirmatively choose “Yes,” no receivables insurance will be provided on its platform or for any of its transactions.
Default values are indicated above.
If Administrator has not selected insurance parameters or has decided not to enable insurance, this selection area does not appear to the Funder.

t. UCC fee?—This “Yes” or “No” field indicates whether Administrator wishes to conduct a UCC search for receivables on its platform. The UCC sections are similar but not identical to the insurance sections. Note that separate selections are made for invoices and recurring-revenue receivables (and, in the future, for other types of receivables).
The first field is “Enable UCC Checks?” The default value is “No.” Clicking it changes the field to “Yes.” Clicking it again changes the field back to “No.”
If the Funder selects “Yes,” the Administrator UCC parameters in the sections following this one are used to calculate the UCC fee for each given receivable.
Other than the “Enable UCC options, the remaining UCC fields are grayed out until and unless “Yes” is selected. If so, then everything is made visible and selectable except for the table described below.
The second field is labeled “Conduct UCC checks . . . ” with a dropdown with the choices “Every time,” “Every week,” “Every month,” “Every quarter,” and “Every year.” The default value is whatever Administrator has selected. (UCC searches are conducted only on the Buyer company, and so this selection applies to the appearance of individual Buyers. For instance, if the Buyer is Amazon, the selection “Conduct UCC searches every month” would indicate that, when a UCC search is conducted on Amazon, another UCC search does not have to be conducted on Amazon for another month, no matter how many receivables during that period have Amazon as the Buyer.) This field is grayed-out unless the “Enable UCC checks?” selection is set to “Yes.”
The Funder next selects the options (with radio buttons): (1) “Require for all invoices” or “Require for all recurring contracts”; and (2) Require based on SuRF Score. Again, the default value is whatever Administrator has selected.
The choice made by Administrator in each case (invoices or recurring-revenue receivables) is selected by default.
If Administrator has selected the first option for either or both of the receivable types, then if the Funder clicks the second option, the table below becomes active and selectable for that type. Rechecking the first option grays the table out again but leaves any entered values in place.
If Administrator has selected the second option (“Require based on SuRF Score”) for either or both of the receivable types, then the table is already active and selectable for that type. Again, if the Funder then checks the first option, it grays out the table for the selected type.

For Combined SuRF Scores:* Do the Following:

| From | To | |
|---|---|---|
| 00 | 100 | Fund without requiring UCC checks |
| 00 | 00 | Fund only with satisfactory UCC checks |
| 0 | 00 | Do not fund |

*(Seller SuRF Score * Buyer SuRF Score)/100

If Administrator has selected the second option, Administrator must fill in all of the grayed-out numbers with whole numbers. No lower-level number may be higher than a higher-level number.
There also can be no separation between succeeding numbers. For instance, if the upper left number is 90, then the middle-right number must be 89.
A given number (other than 100) includes all decimals above that number. For instance, 90 includes 90.01, 90.1, 90.2, all the way up to 90.9999999 . . .
If two numbers in a row are the same, then there are no receivables in that row, and the next upper-left number is automatically the same (except for the top row). For instance, if the two numbers in the middle row are 80, then the upper-left number must be 80 as well.
This is an optional field. If the Funder does not affirmatively choose “Yes,” no UCC checks will be provided on its platform or for any of its transactions.
Default values are indicated above.
If UCC searches are enabled and a UCC result is required, receivables in any category in which a UCC search is required for which a UCC result is not found cannot be funded nor will an offer be made.
This is an optional field. If the Funder does not affirmatively choose “Yes,” no UCC searches will be provided on its platform or for any of its transactions.
If Administrator has not selected UCC parameters or has decided not to enable UCC searches, this selection area does not appear to the Funder.

u. Broker's fee. This is fee charged as a percentage of a receivable's value for a broker to bring receivables to the Funder. There are no separate fields for invoices and recurring-revenue receivables.
There is a “Yes”/“No” field. The Administrator selection is checked by default. If Administrator has not made a selection, then “No” is checked by default.
There is also a numeric-entry field, representing the level of the fee, entered through a 2-decimal-point percentage entry field, from 0.00% to 99.99%. The field includes a gray entry by default. It cannot be edited as long as “No” is checked. If Administrator has made an entry, that value shows in gray by default. Otherwise, the gray figure is “0.00%.”
If “Yes” is checked in the “Yes”/“No” field (either by Administrator or by the Funder), then the numeric-entry field becomes editable.
If “No” is checked again, any entered values remain, but become gray and non-editable.
This is an optional field. If no selection and numeric entry is made by the Funder (whether or not Administrator has selected “Yes” and/or a value), the numeric-entry field remains gray, and there is no broker's fee.
Note: Even if a broker's fee has been chosen, not all receivables may come by way of a broker. If a receivable comes by way of a broker, a “1” is passed to the calculator (Cell G14); if a receivable does not come by way of a broker, a “0” is passed to the calculator (Cell G14).
Note: Changes in Funder parameters apply to all future receivables uploads from the time of the change forward.
Returning to FIG. 1, at step 103 a parameterized model is generated based at least in part on the plurality of network-host parameters and the plurality of network-client parameters, the parameterized model being generated by integrating the plurality of network-host parameters and the plurality of network-client parameters into an authorized token transfer generation subroutine.

In the invoice based funding context, a parameterized pricing model is generated based at least in part on the plurality of administrator parameters and the plurality of funder parameters, the parameterized pricing model being generated by integrating the plurality of administrator parameters and the plurality of funder parameters into an invoice/receivable pricing subroutine.

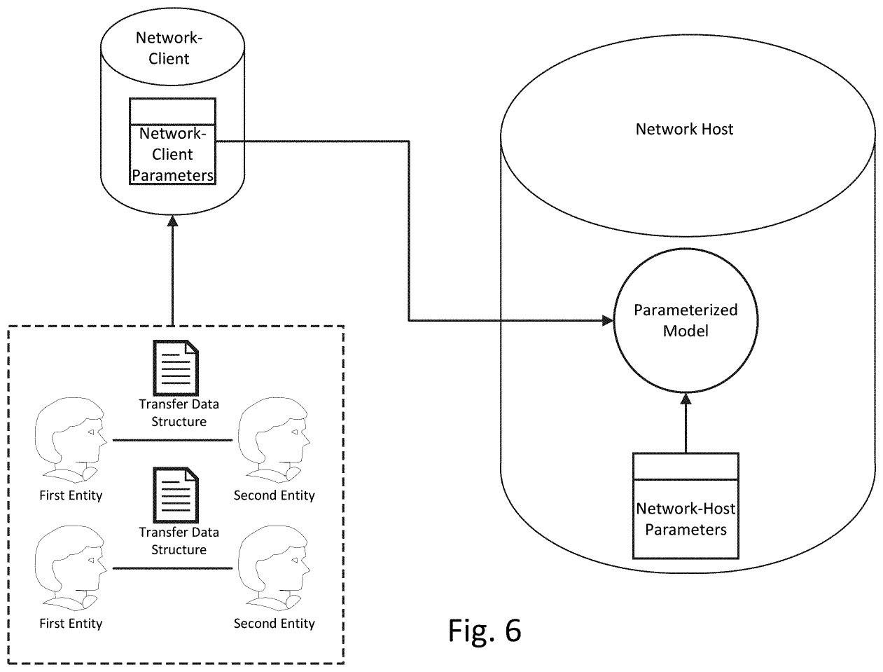

FIG. 6 illustrates the process for generating the parameterized model according to an exemplary embodiment. The network-client parameters are provided from the network-client to the parameterized model, which includes an authorized token transfer generation subroutine, and the network parameters are also provided to the parameterized model. The network-client parameters and network-host parameters are then used to customize the parameterized model according to particular deployment. In other words the network-client parameters and network-host parameters are used to generate a parameterized model customized to the particular deployment.

In the invoice based funding context, the funder parameters are provided from the funder system to the parameterized pricing model and the administrator parameters are also provided to the parameterized pricing model. The parameterizing pricing model includes an invoice/receivable pricing subroutine. The funder parameters and administrators parameters are then used to customize the parameterized pricing model according to particular deployment. In other words the funder parameters and administrators parameters are used to generate a parameterized pricing model customized to the particular deployment.

Returning to FIG. 1, at step 104 a plurality of transfer data structures are received, each transfer data structure identifying a first entity having requirements associated with a transfer to a second entity, the second entity having collection authority to receive the transfer from the first entity, and one or more transfer parameters governing the transfer.

In the invoice based funding context, this step can include receiving a plurality of receivables, each receivable including a buyer (first entity), a seller (second entity), and one or more receivable parameters corresponding to that receivable (transfer parameters).

The receivable parameters can include, for example, an invoice amount, an administrator fee, an insurance fee percentage, a uniform commercial code fee, a fee period, a maximum weekly interest rate, a maximum monthly interest rate, a base holdback percentage, a maximum base holdback percentage, an insurance repayment percentage, a fund size, a fund cycles parameter, an additional funding parameter, a funder profit retention flag, a funder profit retention percentage, an administrator profit retention flag, and/or an administrator profit retention percentage.

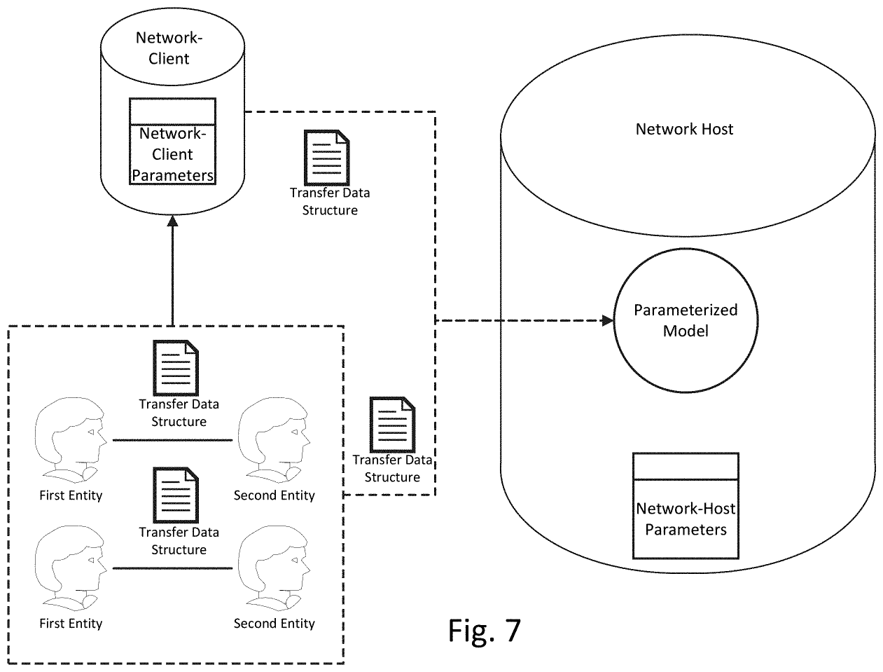

FIG. 7 illustrates a system chart showing the transfer of transfer data structures to the network host and the parameterized model. As shown in FIG. 7, the transfer data structures can be transmitted directly from first or second entities to the network host or can be transmitted via the network client.

In the invoice based funding context, the receivables/invoices can be transmitted from the seller or buyer computing systems (e.g., via a web portal) or through the funder computing system (in the event that buyers/sellers register through a funder account with the platform). The process for staging and processing receivables is discussed in greater detail further below. In the event that a buyer listed on the receivable is registered with the platform, the buyer can transmit the receivable to the platform.

Returning to FIG. 1, at step 105, the parameterized model is applied to the plurality of transfer data structures to determine a plurality of network-client adjustment rates and a plurality of authorized token transfers, each network-client adjustment rate and each authorized token transfer corresponding to a transfer data structure in the plurality of transfer data structures.

Each authorized token transfer comprises a transmission of a non-fungible token (NFT) from a distributed ledger address of a second entity identified by the corresponding transfer data structure to a distributed ledger address of the network-client and wherein transmission of the NFT transfers collection authority for the corresponding transfer data structure from the second entity to the network-client in exchange for a reverse transfer from the network-client to the second entity.

In the invoice based funding context, the parameterized pricing model is applied to the plurality of receivables to determine a plurality of discount rates (network-client adjustment rates) and a plurality of approved offers (reverse transfers) corresponding to a plurality of approved receivables transfer tokens (authorized token transfers). Each of the approved receivables transfer tokens is transferred from the corresponding seller to the funder and transfers the collection privileges for that receivable from the seller to the funder. This can be implemented as described in U.S. Provisional Application No. 63/331,150, filed Apr. 14, 2022 or U.S. Provisional Application No. 63/331,16, filed Apr. 14, 2022, the disclosure of which are hereby incorporated by reference in their entirety.

Each approved offer can indicate an offer price from the funder to a seller of each approved receivable for sale of the approved receivable to the funder.

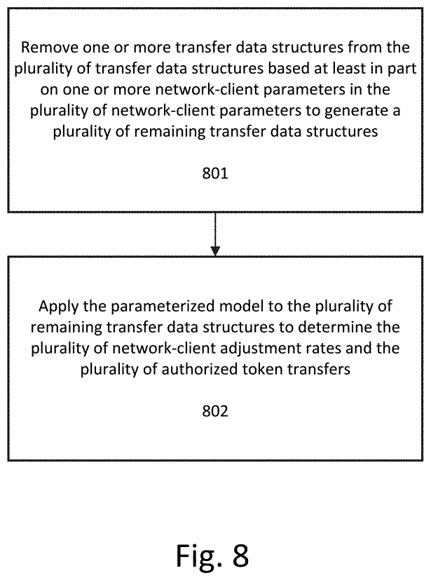

FIG. 8 illustrates a flowchart for applying the parameterized model to the plurality of transfer data structures to determine a plurality of network-client adjustment rates and a plurality of authorized token transfers according to an exemplary embodiment.

At step 801 one or more transfer data structures are removed from the plurality of transfer data structures based at least in part on one or more network-client parameters in the plurality of network-client parameters to generate a plurality of remaining transfer data structures.

In the invoice based funding context, one or more receivables are removed from the plurality of receivables based at least in part on one or more funder parameters in the plurality of funder parameters to generate a plurality of remaining receivables. This filtering/disqualification process removes receivables from consideration for funding based upon the funders parameters and/or the administrator parameters and is explained in greater detail in the sections below on invoice pricing and recurring receivable pricing.

At step 802 the parameterized model is applied to the plurality of remaining transfer data structures to determine the plurality of network-client adjustment rates and the plurality of authorized token transfers

In the invoice based funding context, the parameterized pricing model is applied to the plurality of remaining receivables to determine the plurality of discount rates and the plurality of approved offers corresponding to the plurality of approved receivables in the plurality of receivables.

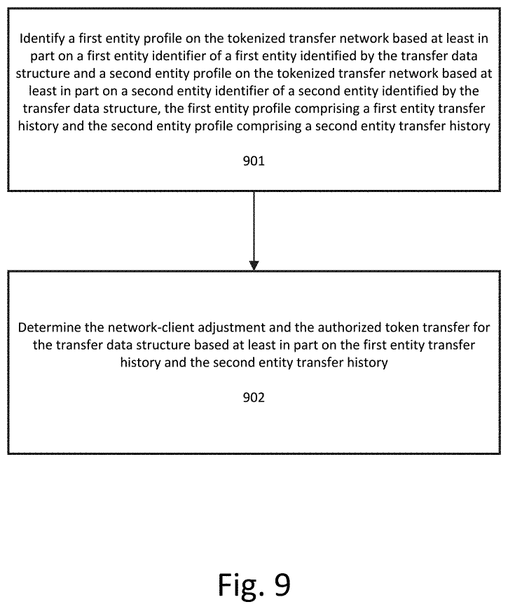

FIG. 9 illustrates a flowchart for applying the parameterized model to the plurality of remaining transfer data structures to determine the plurality of network-client adjustment rates and the plurality of authorized token transfers according to an exemplary embodiment. FIG. 9 illustrates the process that is performed when applying the parameterized model to each transfer data structure in the plurality of remaining transfer data structures.

In the invoice based funding context, the process shown in FIG. 9 describes the process for determining discount rates and offers at a high level and this process is explained in more detail with respect to the sections on invoice pricing and recurring receivable pricing.

Generally, the order in which the input information is vetted and analyzed can be: (1) Seller (supplier) is vetted and scored when the Seller signs up; (2) Buyers are vetted and scored whenever the first invoice sent to them is uploaded; and (3) Each invoice/receivable is vetted and scored as it is uploaded, simultaneously with the Buyer if it is the Buyer's first appearance. Vetting and scoring thereafter take place on an ongoing basis in the background.

At step 901 a first entity profile is identified on the tokenized transfer network based at least in part on a first entity identifier of a first entity identified by the transfer data structure and a second entity profile on the tokenized transfer network based at least in part on a second entity identifier of a second entity identified by the transfer data structure, the first entity profile comprising a first entity transfer history and the second entity profile comprising a second entity transfer history.

In the invoice based funding context, each receivable comprises a buyer identifier corresponding to the buyer and a seller identifier corresponding to the seller. In step 901 in the invoice based funding context, a buyer profile is identified on the receivable financing platform on the computer network based at least in part on the buyer identifier and a seller profile is also identified on the receivable financing platform on the computer network based at least in part on the seller identifier. The buyer profile includes a buyer transaction history and the seller profile includes a seller transaction history.

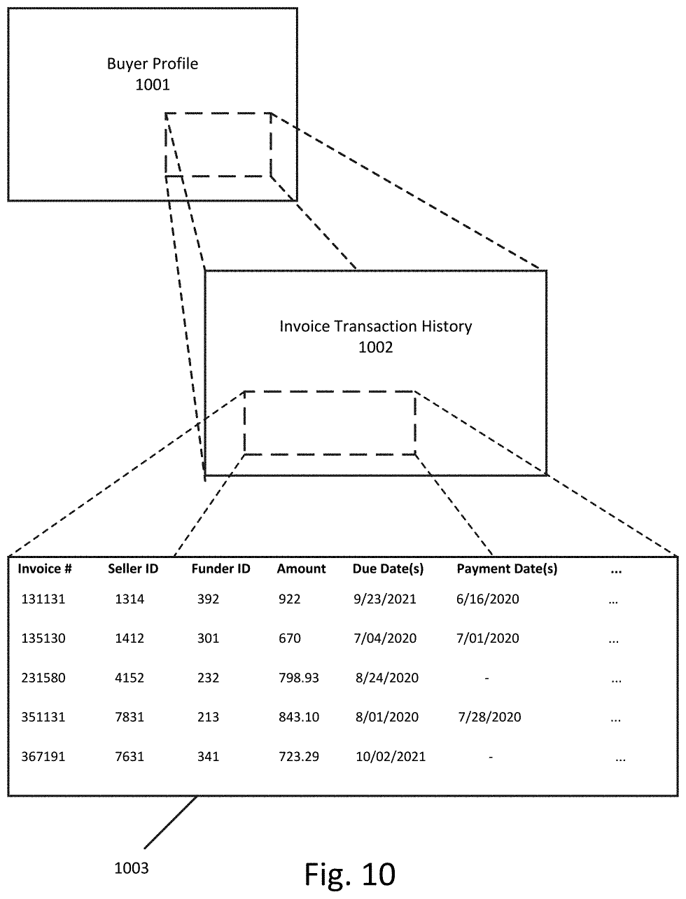

FIG. 10 illustrates an example of the buyer profile and receivable/invoice transaction history according to an exemplary embodiment. As shown in FIG. 10, buyer profile 1001 includes invoice transaction history 1002. Box 1003 illustrates an example of a portion of the invoice transaction history. The transaction history can include, for example, invoice numbers/identifiers, seller identifiers associated with invoices, and invoice amounts. The transaction history also includes funder information associated with particular invoices, such as the identifier or name of a funder that previously provided funding pertaining to a particular invoice. The transaction history can include one or more due dates, such as the due date for the invoice amount, the due date of repayment of financing, etc. The transaction history can also include payment dates, such as the date of payment of the invoice by the buyer, the date of repayment of financing by the seller, etc. The transaction history can include additional information not shown in FIG. 10, such as invoice terms, conditions, invoice issue date, or any other pertinent information for the invoice, the buyer, the seller, or the funder. Note that the transaction history is global and can utilized regardless of funder—i.e., it is a global transaction history.

The transaction history can record the following transactions (including their amounts, dates, timing, and parties):

Payment of an invoice by the Buyer to the Seller

Non-payment of an invoice by the Buyer to the Seller

Repayment of invoice-funding by the Seller to the Funder

Non-repayment of invoice-funding by the Seller to the Funder

Each new Buyer-Seller transaction (or non-transaction) and each new Seller-Funder transaction thereafter will be added to the various measures on an incremental basis until internal measurements and activities dominate buyer and seller risk metrics, as described in greater detail below.

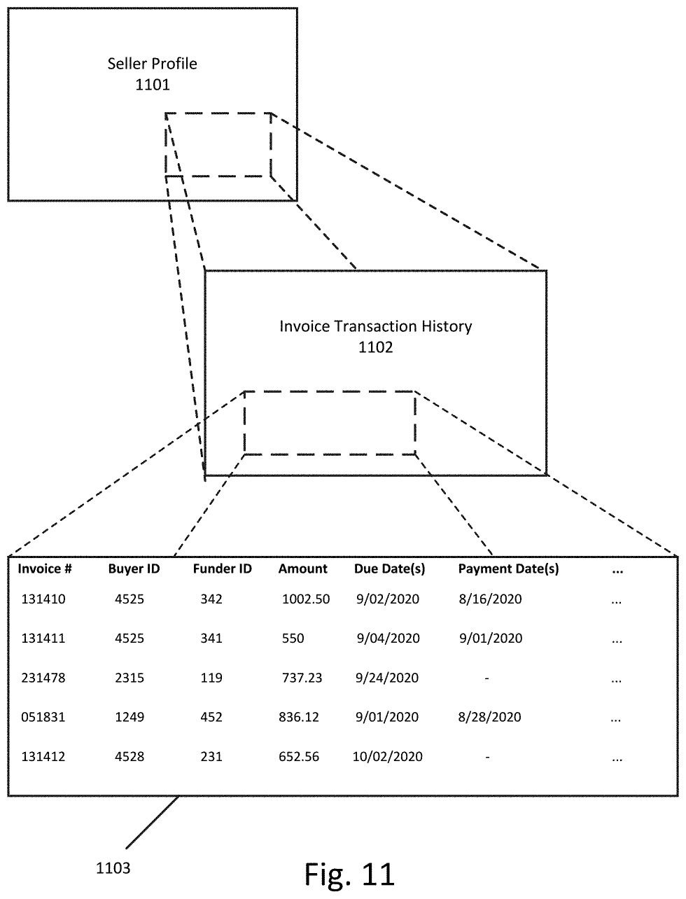

FIG. 11 illustrates an example of the seller profile and invoice transaction history according to an exemplary embodiment. As shown in FIG. 11, seller profile 1101 includes invoice transaction history 1102. Box 1103 illustrates an example of a portion of the invoice transaction history. The transaction history can include, for example, invoice numbers/identifiers, buyer identifiers associated with invoices, and invoice amounts. The transaction history also includes funder information associated with particular invoices, such as the identifier or name of a funder that previously provided funding pertaining to a particular invoice. The transaction history can include one or more due dates, such as the due date for the invoice amount, the due date of repayment of financing, etc. The transaction history can also include payment dates, such as the date of payment of the invoice by the buyer, the date of repayment of financing by the seller, etc. The transaction history can include additional information not shown in FIG. 11, such as invoice terms, conditions, invoice issue date, or any other pertinent information for the invoice, the buyer, the seller, or the funder.

Similar to the buyer transaction history, the seller transaction history can record the following transactions (including their amounts, dates, timing, and parties):

Payment of an invoice by the Buyer to the Seller

Non-payment of an invoice by the Buyer to the Seller

Repayment of invoice-funding by the Seller to the Funder

Non-repayment of invoice-funding by the Seller to the Funder

Each new Buyer-Seller transaction (or non-transaction) and each new Seller-Funder transaction thereafter will be added to the various measures on an incremental basis until internal measurements and activities dominate buyer and seller risk metrics, as described in greater detail below.

The buyer invoice transaction history can also be extracted from a subset of the seller transaction history. For example, if a particular invoice has seller=XYZ and buyer=ABC, then the invoice transaction history for seller XYZ can be retrieved and filtered to identify all records relating to buyer ABC. In this way, the invoice transaction history can more accurately reflect the data and trends relating to a particular seller and buyer pairing.

Returning to FIG. 9, at step 902, the network-client adjustment and the authorized token transfer for the transfer data structure are determined based at least in part on the first entity transfer history and the second entity transfer history.

In the invoice based funding context, this step includes determining a discount rate and offer for the receivable based at least in part of the buyer history and the seller history. In the invoice based funding context, this step can include multiple sub-steps, as described below.

This step can include the sub-step of determining a seller overall probability of default is based at least in part on a plurality of seller-default variables and a plurality of dynamic seller-default weights associated with the plurality of seller-default variables. The plurality of seller-default variables can include a seller integrity score, one or more secondary probability of default scores associated with the seller, and/or a seller internal probability of default. Current values of the plurality of dynamic seller-default weights are determined based at least in part on real-time monitoring of transactions in the seller transaction history of the seller profile.

Additionally, this step can include the sub-step of dynamically determining, based upon the seller transaction history a seller overall projected days-beyond-term (DBT), which is a measure of how many days beyond term a seller is projected to pay the balance of the invoice. The seller overall projected DBT is based at least in part on a plurality of seller-DBT variables and a plurality of dynamic seller-DBT weights associated with the plurality of seller-DBT variables.

This step can include the sub-step of determining a buyer overall probability of default based at least in part on a plurality of buyer-default variables and a plurality of dynamic buyer-default weights associated with the plurality of buyer-default variables. The plurality of buyer-default variables can include a buyer integrity score, one or more secondary probability of default scores associated with the buyer, and a buyer internal probability of default. Current values of the plurality of dynamic buyer-default weights are determined based at least in part on real-time monitoring of transactions in the buyer transaction history of the buyer profile.

Additionally, this step can include the sub-step of determining, based upon the buyer transaction history, a buyer overall projected days-beyond-term (DBT), which is a measure of how many days beyond term a buyer is projected to pay the balance of the invoice. The buyer overall projected DBT is based at least in part on a plurality of buyer-DBT variables and a plurality of dynamic buyer-DBT weights associated with the plurality of buyer-DBT variables.

The seller overall probability of default and project DBT can be based upon a seller internal probability of default (based upon data in the invoice transaction database) and internal projected DBT (based upon data in the invoice transaction database), as well as additional measures of probability default determined or projected DBT based on other scoring systems or public data about the seller. Similarly, the buyer overall probability of default and project DBT can be based upon a buyer internal probability of default (based upon data in the invoice transaction database) and internal projected DBT (based upon data in the invoice transaction database), as well as additional measures of probability default determined or projected DBT based on other scoring systems or public data about the buyer. Additionally examples and explanations relating to the determination of these measures can be found in U.S. Provisional Application No. 63/075,513, previously incorporated by reference.

Optionally, the discount rate and offer for the receivable can be determined based at least in part on the seller overall probability of default, the buyer overall probability of default, and the corresponding one or more receivable parameters. This step is described in greater detail with respect to the section on invoice pricing and recurring revenue pricing.

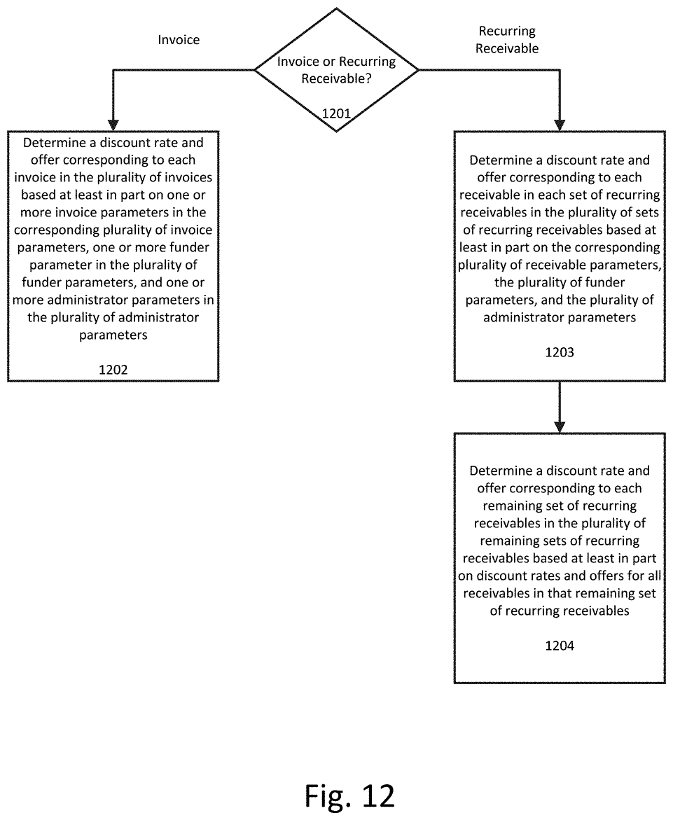

As explained previously, in the invoice/receivable based funding context, receivables can include invoices or recurring receivables (such as monthly contracts). As shown in FIG. 12, these can be treated differently when applying the parameterized pricing model. Invoices have a single repayment at a single point in time, whereas recurring-revenue contracts (i.e., sets of recurring receivables) have, e.g., 12 repayments over a 12-month horizon. Because discount rates and offers are based in part on the time value of money, each repayment for a recurring-revenue contract must be priced separately—in effect, a 12-month recurring-revenue contract is treated as 12 separate invoices of equivalent amount but different term. These 12 sets of information are then aggregated and a single discount rate and offer is determined.

FIG. 12 illustrates a flowchart for another aspect of applying the parameterized pricing model to the plurality of remaining receivables to determine the plurality of discount rates and the plurality of approved offers corresponding to the plurality of approved receivables in the plurality of receivables according to an exemplary embodiment.

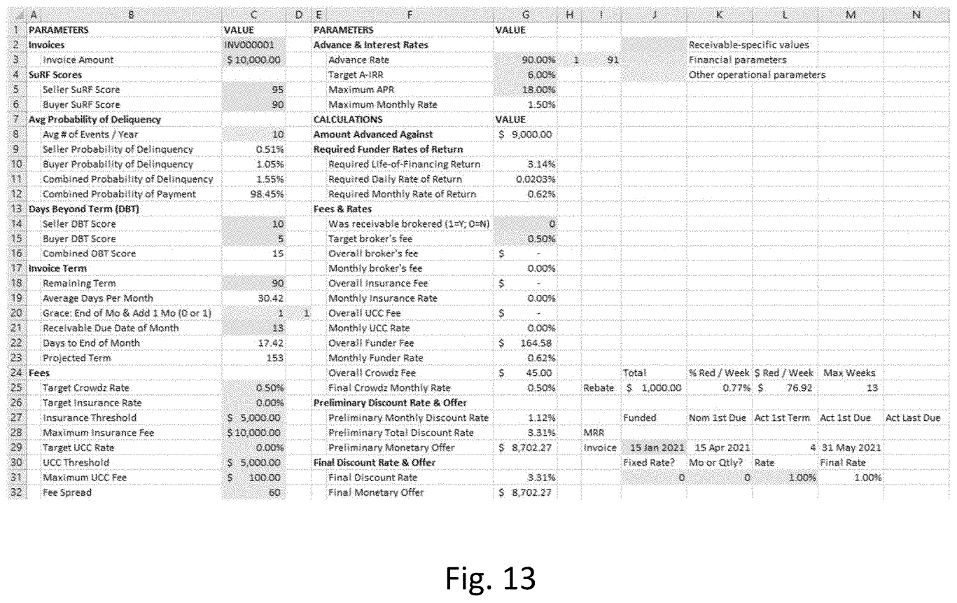

At step 1201 it is determined whether remaining receivables are invoices or recurring receivables. If the remaining receivables include a plurality of invoices and the plurality of receivable parameters comprise a plurality of invoice parameters, then at step 1202 a discount rate and offer are determined corresponding to each invoice in the plurality of invoices based at least in part on one or more invoice parameters in the corresponding plurality of invoice parameters, one or more funder parameter in the plurality of funder parameters, and one or more administrator parameters in the plurality of administrator parameters. The discount rate and offer determination process for invoices is described in greater detail below with respect to the spreadsheet shown in FIG. 13. The cell numbers referenced in the section below reference the spreadsheet shown in FIG. 13, which illustrates an example of applying the parameterized model to an invoice.

Invoice Discount Rate and Offer Determination (Pricing)

Once invoices are uploaded, they are automatically assigned a discount rate and offer price, as described below. Please see FIG. 13 for specific calculations. A separate set of calculations is performed for each invoice, using Funder parameters (see the “Funder Parameters” spec in The Funder Parameters section), as modified by the Administrator Parameters (see the “Administrator Parameters” spec in The Administrator Parameters section).

This spec is accompanied by the “Discount Rates & Offers—Recurring Revenue” spec in The Recurring Revenue Pricing section, which describes a similar parameterization and calculation process for recurring-revenue receivables.

Remove Disqualified Invoices

Before invoices are scored, the system automatically removes those that do not meet the Funder's specific qualifications, as enumerated in the “Funder Parameters” spec in The Funder Parameters section (note: funding-limit restrictions are discussed in the “Funding Limit & Auto-Funding” spec in The Funding Limit and Auto-Funding section). Specifically:

Maximum receivable amount. The invoice's value exceeds the maximum value of any one receivable, if a maximum value has been set (item d in the “Funder Parameters” spec in The Funder Parameters section).

Minimum acceptable SuRF Scores. The invoice fails to meet the minimum SuRF Score for one or more of the Seller, the Buyer, and the combined receivable scores, if the relevant values have been set (item j).

Minimum remaining term for receivables. The invoice fails to meet the minimum remaining term for receivables, if a minimum value has been set (item k).

Maximum remaining term for receivables. The invoice exceeds the maximum remaining term for receivables, if a maximum value has been set (item 1).

Bankruptcy experiences. There are either too many bankruptcies on record for the Seller and/or the most recent bankruptcy is too recent (item m).

UCC experiences. There are either too many UC reports on record for the Seller and/or the most recent UCC report is too recent (item n).

Minimum acceptable bond rating for Sellers and/or Buyers. Either the Seller and/or the Buyer of the invoice, if it has a bond rating, has a bond rating that falls below the minimum, if the relevant values have been set (item o).

Acceptable industries. The Seller does not belong to an industry on the Funder's acceptable-industries list (item p).

Acceptable geographies. The Seller is not located in a geographical area on the Funder's acceptable-geographies list (item q).

Minimum acceptable sustainability score. The Seller's sustainability score does not meet the minimum acceptable sustainability score, if a minimum has been set, or else it does not possess a sustainability score, if one is required (item r).

Note: Some of the above constraints will have different values for invoices and recurring-revenue receivables; in cases in which the values differ, for this The Invoice Pricing section spec, make sure to use the value for invoices.

Disqualified receivables from a given funding environment flow into the nearest downstream funding environment for processing, once implemented (see description in the “Funding Limits & Auto-Funding” spec in The Funding Limit and Auto-Funding section).

Setup for the Automated Calculation:

If the Funder has chosen a fixed discount rate (item fin the “Funder Parameters” spec in The Funder Parameters section), proceed to the “Fixed Rate” section below. Note: The cell references below refer to cells in the attached spreadsheet (Calculations 210810, General tab).

Invoice amount (Cell C3). The invoice amount (face value) is derived directly from the data for the invoice in question.

SuRF Scores (Cells C5 & C6). The SuRF Scores are derived directly from the data for the invoice in question.

The Seller's SuRF Score (Cell C5) is already known upon the Seller's registration, either currently or previously.

The Buyer's SuRF Score (Cell C6) also may be known if the Buyer is already listed in the system; otherwise, the Buyer's SuRF Score is calculated in real-time in the usual fashion.

If the Buyer's SuRF Score cannot be calculated (due to a lack of information), the Buyer's SuRF Score is assumed, for the purpose of this calculation, to be 90.

Note: this default SuRF Score of 90 is not posted in the Administrator database as the Buyer's SuRF Score, which is listed as “TBD” if no other information is available; however, the default SuRF Score of 90 is used for the purpose of calculating the discount rate and offer.

If there are multiple results from the database calls for either the Seller, the Buyer, or both, calculations cannot proceed until the Seller selects a company name from the options.

Average probability of delinquency (Cells C8 to C12). There are a number of factors used to calculate the average probability of delinquency for the Sellers and Buyers:

Average number of events per year (Cell C8). A parameter used in calculating the delinquency probabilities, entered on the Administrator Parameters screen.

Seller probability of delinquency (Cell C9). Calculated as: 1−EXP(LN((C5/100)/C8). Note: variables in equation refer to the cell number in the spreadsheet, e.g., C5=the value in Cell C5.

Buyer probability of delinquency (Cell C10). Calculated as: 1−EXP(LN((C6/100)/C8).

Combined probability of delinquency (Cell C11). Calculated as: 1−((1−C9)*(1−C10)).

Combined probability of payment (Cell C12). Calculated as: 1−C11.

Days Beyond Term (DBT) Scores (Cells C14 to C16). Days beyond term are the projected number of days by which the party will be late in paying/repaying (beyond the respective due date).

The Seller's DBT Score (Cell C14) is already known upon the Seller's registration, either currently or previously.

The Buyer's DBT Score (Cell C15) also may be known if the Buyer is already listed in the system; otherwise, the Buyer's DBT Score is calculated in real-time in the usual fashion.

If the Buyer's DBT Score cannot be calculated (due to a lack of information), the Buyer's DBT Score is assumed, for the purpose of this calculation, to be 0.

Note: this default DBT Score of 0 is not posted in the Administrator database as the Buyer's DBT Score, which is listed as “TBD” if no other information is available; however, the default DBT Score of 0 is used for the purpose of calculating the discount rate and offer.

If there are multiple results from the database calls for either the Seller, the Buyer, or both, calculations cannot proceed until the Seller selects a company name from the options.

The Combined DBT Score (Cell C16) is calculated as: C14+C15.

Invoice term (Cells C18 to C23). The invoice term is the projected time (in days) from the date of invoice financing (purchase) to the date on which the financing is expected to be repaid. Its calculation uses the following factors:

Remaining term (Cell C18). This is the number of days left in the invoice's stated term, as drawn from the invoice data.

Average days per month (Cell C19). This is calculated as 365/12.

Add end-of-month's grace period (0 or 1) (Cell C20). This is a factor, entered on the Funder Parameters screen (as described in the “Funder Parameters” spec, item i, in The Funder Parameters section) that indicates whether the Funder is willing to give the Seller until the end of the month in which repayment is due in order to repay the funding. If so, then the Seller is able to take advantage of the consolidated repayments option (see the “Consolidated Repayments” spec in The Consolidated Repayments section). An incremental, time-based discount fee is charged for this privilege.

Add Month's Grace (0 or 1) (Cell D20). This is a factor, entered on the Funder Parameters screen (as described in the “Funder Parameters” spec, item i, in The Funder Parameters section) that indicates whether the Funder is willing to give the Seller an additional month beyond the end of the month in which repayment is due in order to repay the funding. If so, then the Seller is able to take advantage of the consolidated repayments option (see the “—Consolidated Repayments” spec in The Consolidated Repayments section). An incremental, time-based discount fee is charged for this privilege.

Receivable due date of month (Cell C21). This is the day of the month on which the repayment is due.

Days to end of month (Cell C22). This is calculated as C19−C21.

Projected term (Cell C23). This is the projected time from the date of the invoice financing to the date on which the financing is expected to be repaid, and is defined as the “invoice term,” as stated above. It is calculated as: C18+C16+(C22*C20)+(C19*D20).

Fees (Cells C25 to C32). These variables are drawn from the Administrator Parameters Screen for the given deployment, unless the modifiable values are modified by variables drawn from the Funder Parameters Screen. These fees are drawn from the “Funder Parameters” spec, items s & t, in The Funder Parameters section, as modified & augmented by the “Administrator Parameters” spec, items t through dd, in The Administrator Parameters section).

Advance & interest rates (Cells G3 to G6). The interest rates involved in the discount rate and offer calculations are determined as follows:

Advance rate (Cell G3). The percentage of the value of the receivable that Administrator or the Funder is willing to fund against. (See the “Funder Parameters” spec, item h, in The Funder Parameters section.)

Target A-IRR (Cell G4). Administrator or the Funder's target A-IRR (annualized internal rate of return) is extracted from the Administrator or the Funder's Parameters Screens, depending upon which governs. The Target A-IRR may vary from Funder to Funder (i.e., from deployment to deployment). (See the “Funder Parameters” spec, item e, in The Funder Parameters section.)

Maximum APR (Cell G5). Administrator or the Funder's maximum APR (annual percentage rate) is the maximum annualized interest that Sellers within a given deployment may be charged. The variable is extracted from the Administrator or the Funder's Parameters Screens, depending upon which governs. The Maximum APR may vary from Funder to Funder (i.e., from deployment to deployment). (See the “Funder Parameters” spec, item g, in The Funder Parameters section.)

Maximum monthly rate (Cell G6). This value is calculated as: G4/12.

Fixed-rate parameters (Cells J31 to M31). These parameters set forth the discount rate to apply if a fixed rate rather than a variable rate is chosen.

Fixed Rate? (Cell J31). Whether or not a fixed rate has been chosen, with “1” indicating that it has and “0” indicating that it has not. (See the “Funder Parameters” spec, item f, in The Funder Parameters section.)

Mo or Qtly? (Cell K31). Whether the fixed rate is a monthly (value of “2”). Quarterly (value of “1”, or per-receivable (value of “0”) rate. (See the “Funder Parameters” spec, item f, in The Funder Parameters section.)

FR Rate (Cell L31). The rate chosen as the fixed rate, as a percent, regardless of whether it is a monthly rate or an annual rate. (See the “Funder Parameters” spec, item f, in The Funder Parameters section.)

Final rate (Cell M31). The total discount rate for the receivable, taking into account the chosen rate and whether or not it is a monthly, quarterly, or an per-receivable rate. If a fixed rate has been chosen, this value feeds into the discount-rate cell (Cell G31) and thereupon determined the monetary offer (Cell M32).

Calculating Discount Rates & Offers:

Amount advanced against (Cell G8). The value of the invoice against which the financing is rendered (and hence discount rate applied). For instance, for a $10,000.00 invoice at a 90% advance rate, financing is rendered against $9,000.00 ($10,000.00*90.00%). If the discount rate is 5.0%, then the amount financed is (1−5.0%)*$9,000.00=$8,550.00 (instead of $9,500.00 if there were a 100.00% advance rate and the discount rate were applied against $10,000.00 instead of $9,000.00). The amount advanced against is calculated as C3*G3.

Required Funder rates of return (Cells G10 to G12). The required Funder rates of return are the returns that would be required to reward the Funder (or Administrator, if Administrator were the Funder) with its target A-IRR given the invoice's risk profile.

Required life-of-financing return (Cell G10). This is the required rate of return over the time during which the financing is out (including any repayment delays). It is calculated as follows: EXP (C23*LN(((G4+1)/C12)/365)−1

Required daily rate of return (Cell G11). This is the required life-of-financing return reduced to a daily rate. It is calculated as: EXP (LN (1+G10)/C23)−1

Required monthly rate of return (Cell G12). This is the required daily rate of return scaled up to a monthly rate. It is calculated as: ((1+G11)\hat{ }C19)=1

Optimal Funder rates of return (Cells G14 to G16). Funder rates of return are the returns that would be required to reward the Funder (or Administrator, if Administrator were the Funder) if the Seller and Buyer had a combined 100% probability of repayment and a zero combined DBT Score.

Optimal life-of-financing return (Cell G14). This is the optimal rate of return (as defined above) over the time during which the financing is out (including any repayment delays). It is calculated as follows: EXP (C18*LN ((G4+1)/365)−1

Optimal daily rate of return (Cell G15). This is the optimal life-of-financing return reduced to a daily rate. It is calculated as: EXP (LN (1+G14)/C18)−1

Optimal monthly rate of return (Cell G16). This is the optimal daily rate of return scaled up to a monthly rate. It is calculated as: ((1+G15)\hat{ }C19)−1

Fees and rates (Cells G18 to G25). The fees and rates are the percentage and amounts that would be charged for insurance, UCC, the Funder's return, and the Administrator fee.

These are fees that would result in the optimal environment, just described. They also take account of the previously mentioned fee spread.

The values are calculated as documented in Cells G18 to G25. Those rather unwieldy equations are not reproduced here.

Preliminary discount rate and offer (Cells G27 to G29). The preliminary discount rate and offer are what would result in the absence of any fixed-rate considerations (Cells J31 to M31).

Preliminary monthly discount rate (Cell G27). This is the discount rate that would be charged under the above circumstances. It is calculated as: G19+G21+G23+G25

Preliminary total discount rate (Cell G28). This is the monthly discount rate scaled up to the invoice's stated term. It is calculated as: G27*(C18/C19)

Preliminary monetary offer (Cell G29). This is the purchase price of the invoice under the defined optimal conditions. It is defined as: (1−G28)*G8.

Final discount rate and offer (Cells G31 and G32). The final discount rate and offer adjust the preliminary discount rate and offer according to the fixed-rate factors in Cells J31 to M31).

Final discount rate (Cell G31). This is the final discount rate that results after applying the fixed-rate factors in Cells J31 to M31.

Fixed discount rates (Cells J31-M31). The fixed-rate variables are placed in Cells J31 to M31 and feed into the final discount rate (Cell G31): (1) Is there a fixed rate on this invoice? (Cell J31); (2) If there is a fixed rate on this invoice, is the fixed rate a monthly rate? (Cell K31); (3) the fixed-rate value (Cell L31); and (4) the resulting fixed discount rate that feeds into Cell 31).

Final monetary offer (Cell G32). The final monetary offer is then calculated based on the above constraints. It is calculated as follows: (1−G31)*G8

Rebate (Cells J25 to M25). If the advance rate (Cell G3) is less than 100.00% and the Funder has selected to enable rebates for on-time invoice payments (“1” in Cell H3), then the amount of the rebate needs to be calculated, which is performed in Cells J25 to M25. Note: actual processing of rebates is handled by Administrator's payment system.

Total possible rebate (Cell J25). This is the maximum amount of the rebate that the Seller will receive if the invoice-funding is rebate on time. It is the difference between the invoice value (Cell C3) and the amount advanced against (Cell G8).

% reduction per week (Cell K25). This the percentage reduction per week in the total rebate is determined by the total rebate value divided by the Funder-selected expiration-days timing (Cell 13), as calculated in Cell K25.

Monetary-value reduction per week (Cell L25). This is the monetary-value reduction per week in the total rebate is determined by the total rebate value divided by the Funder-selected expiration-days timing (Cell 13), as calculated in Cell L25.

Maximum number of weeks (Cell M25). This is the maximum number of weeks that any rebate will be available, based on the expiration days (Cell 13) and as calculated in Cell M25.

Note: Because the Target A-IRR (along with different decisions on other parameters) can vary from Funder to Funder, each Funder may present a different final discount rate and different final offer to the Seller for the same invoice.

Note: The repayment-date parameters (Cells I27:N29) in FIG. 13 are used in the calculation of consolidated repayments, and are described in the “Consolidated Repayments” spec in The Consolidated Repayments section.

Returning to FIG. 12, if the remaining receivables include a plurality of sets of recurring receivables then at step 1203 a discount rate and offer are determined corresponding to each receivable in each set of recurring receivables in the plurality of sets of recurring receivables based at least in part on the corresponding plurality of receivable parameters, the plurality of funder parameters, and the plurality of administrator parameters.

This results in each receivable within each set of recurring receivable having an associated discount rate and offer. However, since the recurring receivables are packaged together in groups (e.g., a month contract), the aggregate discount rate and offer for each entire set of recurring receivables must be determined. At step 1204 a discount rate and offer corresponding to each remaining set of recurring receivables in the plurality of remaining sets of recurring receivables is determined based at least in part on discount rates and offers for all receivables in that remaining set of recurring receivables.

Discount rates and offers comprise what is referred to as a receivable's “price” and hence their determination constitutes the “pricing” of a receivable.

For instance, assume that a Seller sells a $1,000 invoice to a Funder for an immediate $950 payment:

Face value. The face value of the invoice in question is $1,000.

Discount. The difference between $1,000 and $950, which is $50, is the discount, or the amount that the invoice's value must be reduced by in order to secure a sale of the invoice.

Discount rate. The ratio of the discount to the face value is the discount rate (i.e., $50/$1,000=5.00%). It represents the percentage reduction in the invoice's value, as just described.

Offer. The difference between the face value and the discount is the offer price, or offer (i.e., $1,000−$50=$950). This is the amount of the early-payment that the Funder gives to the Seller.

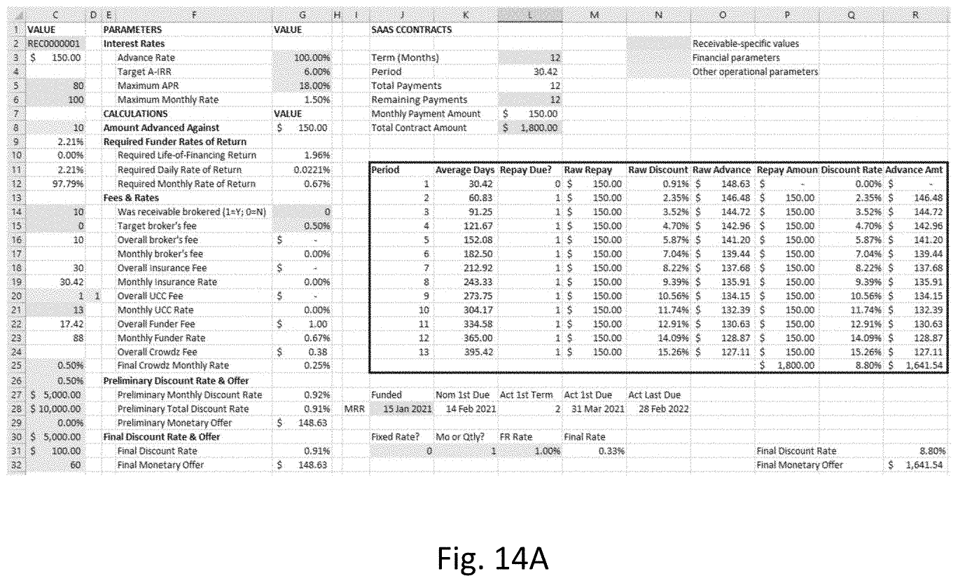

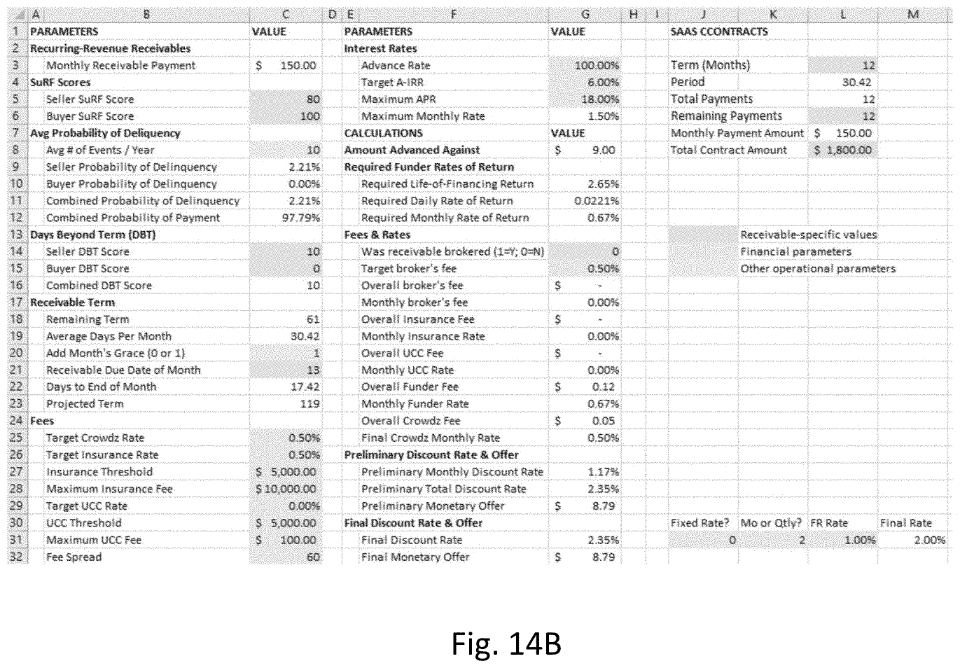

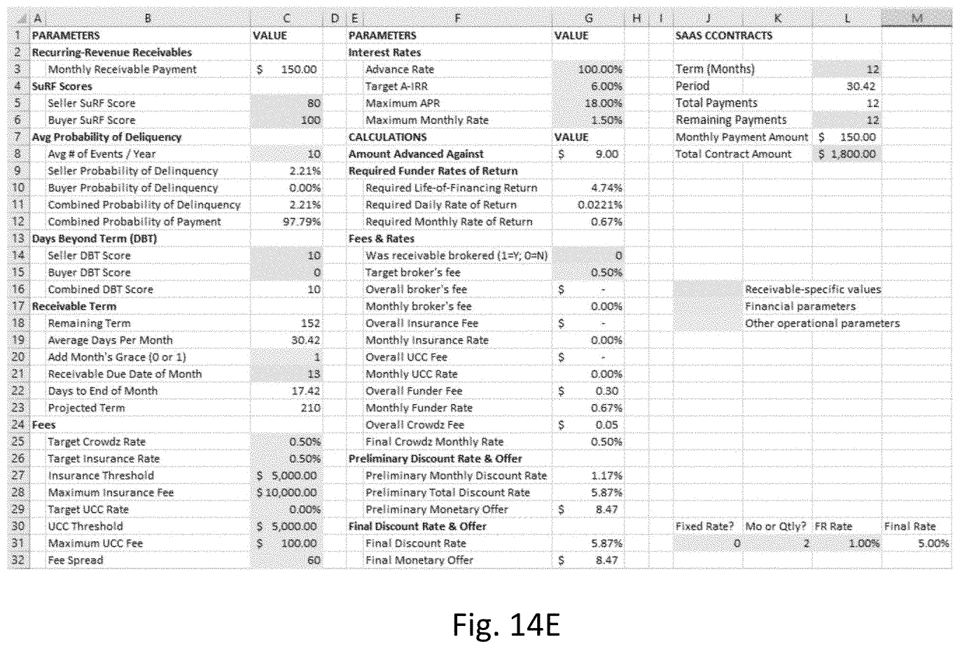

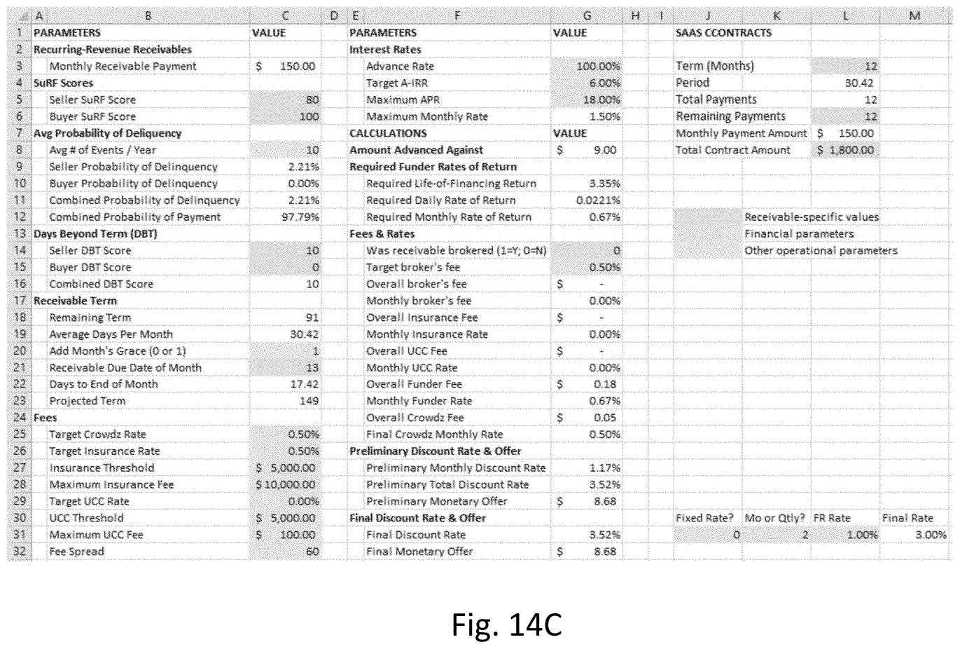

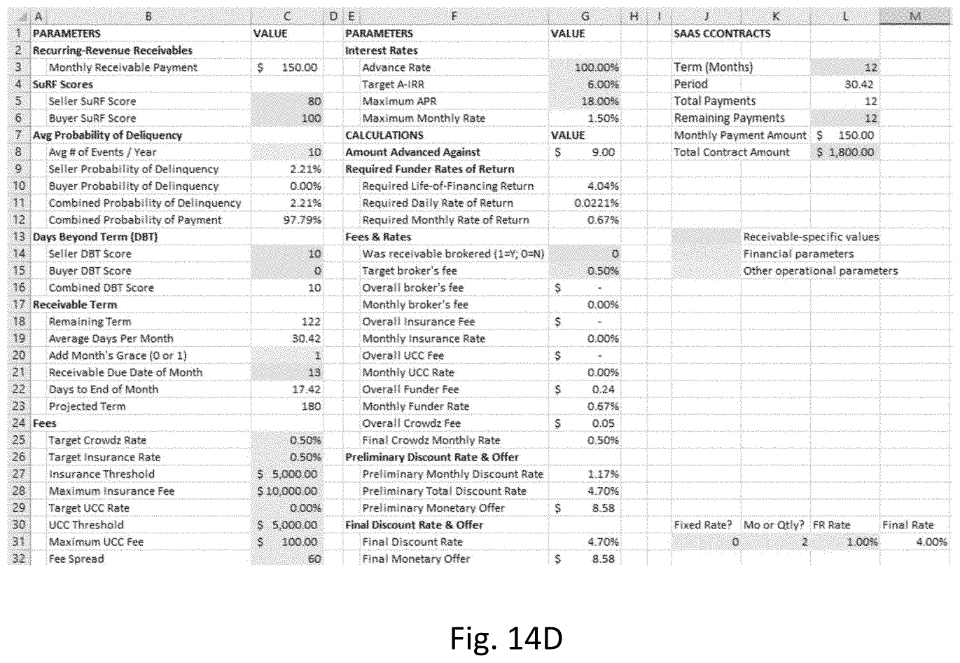

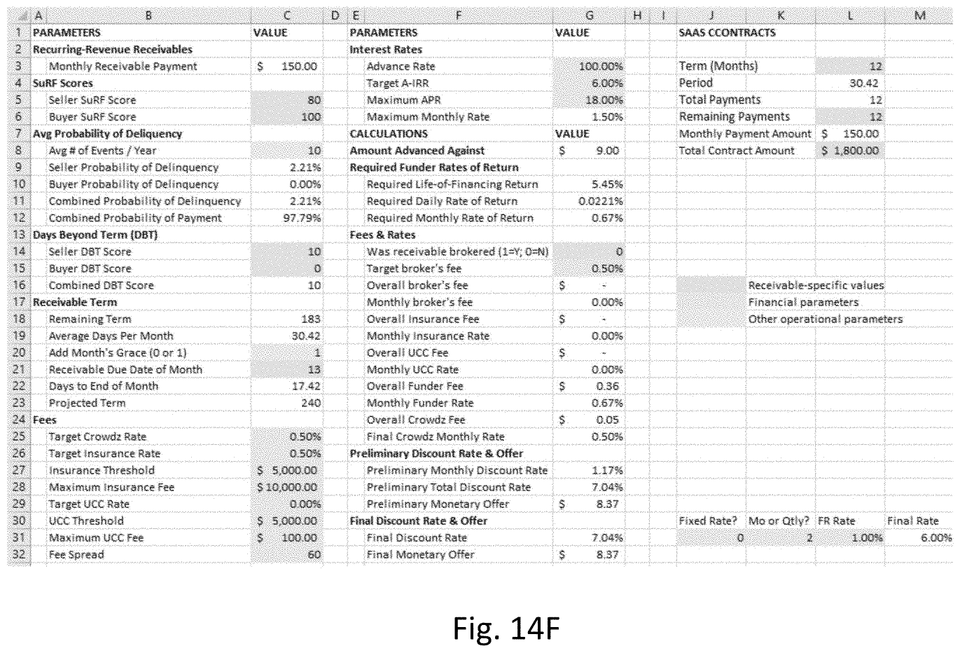

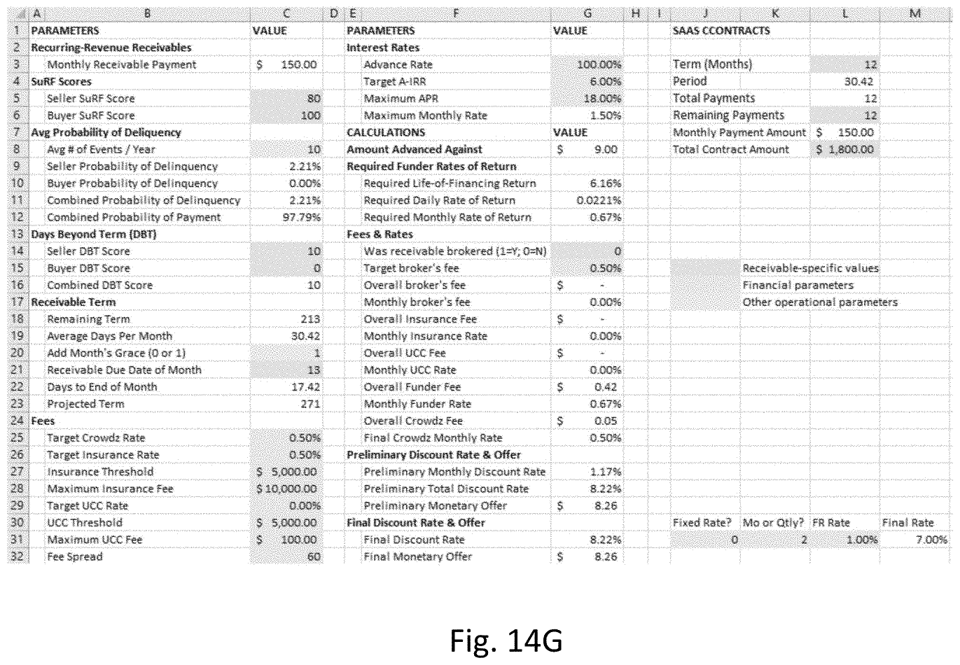

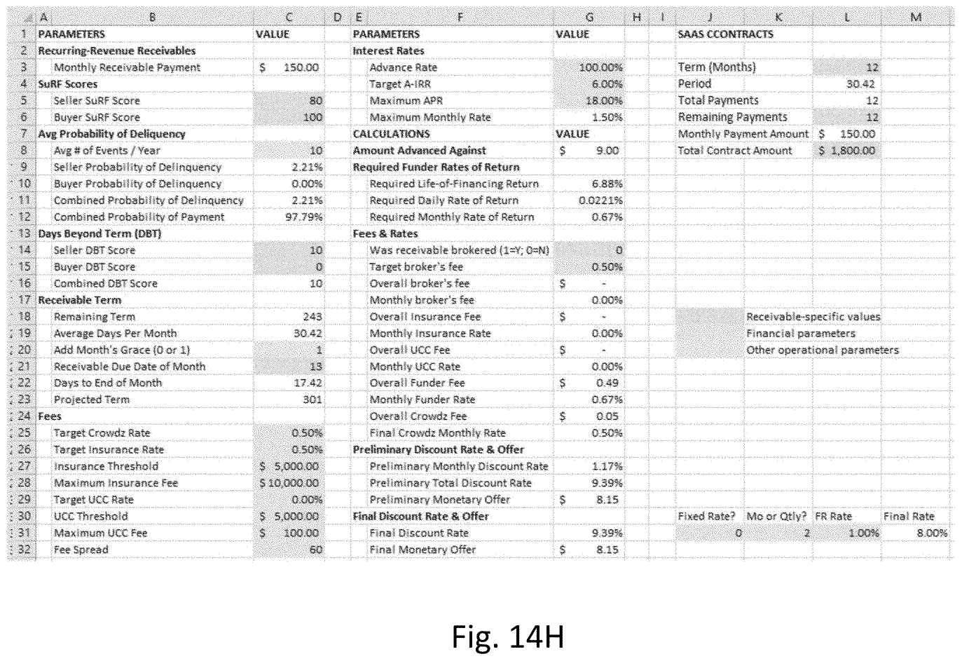

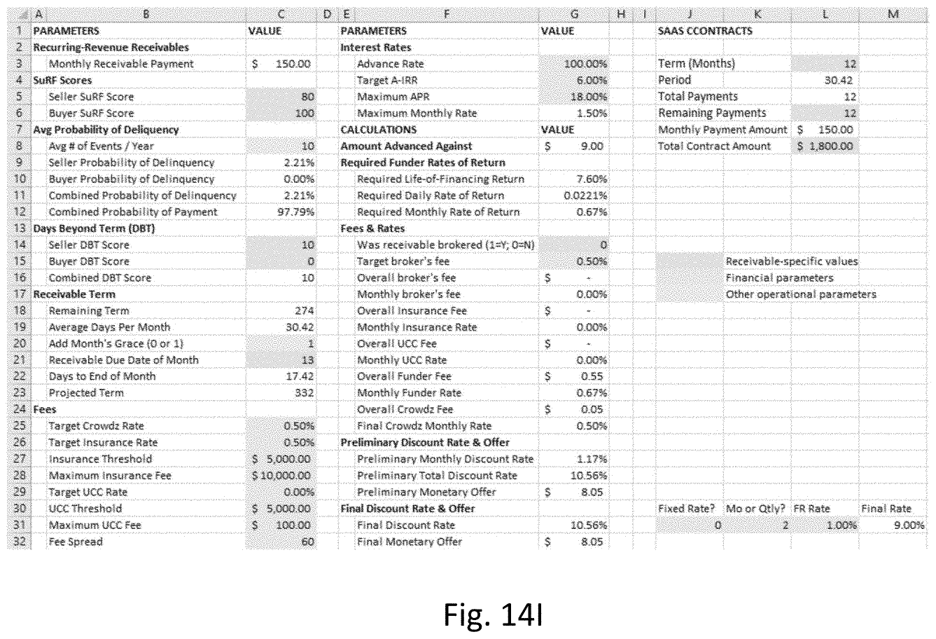

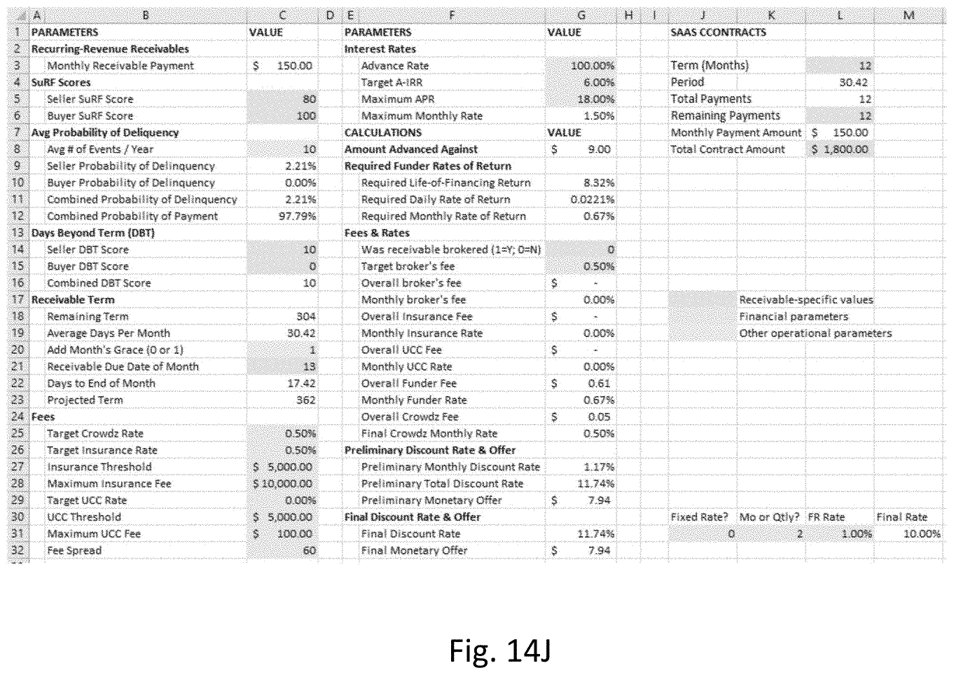

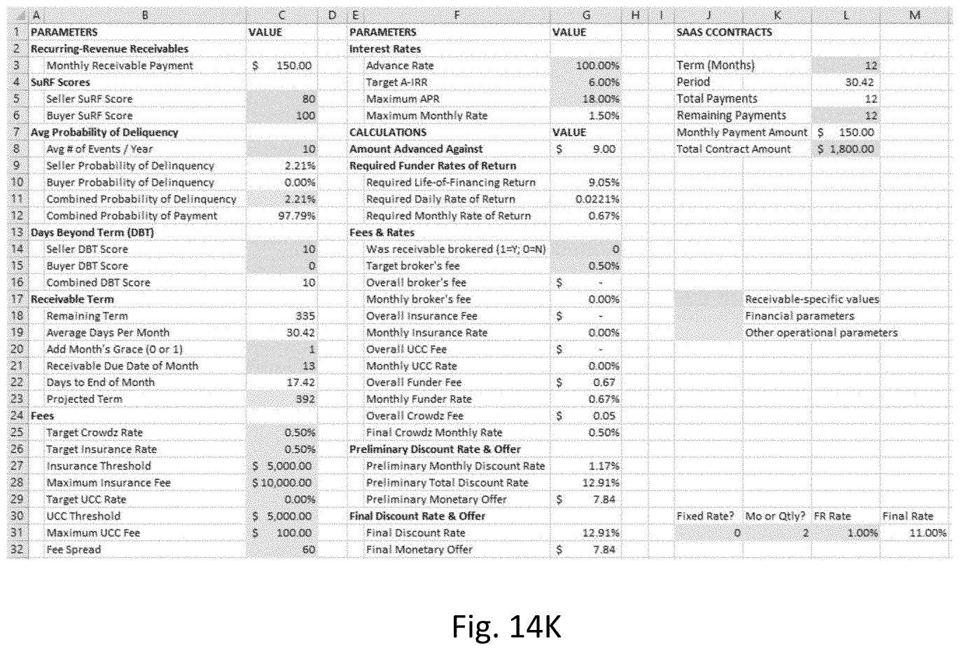

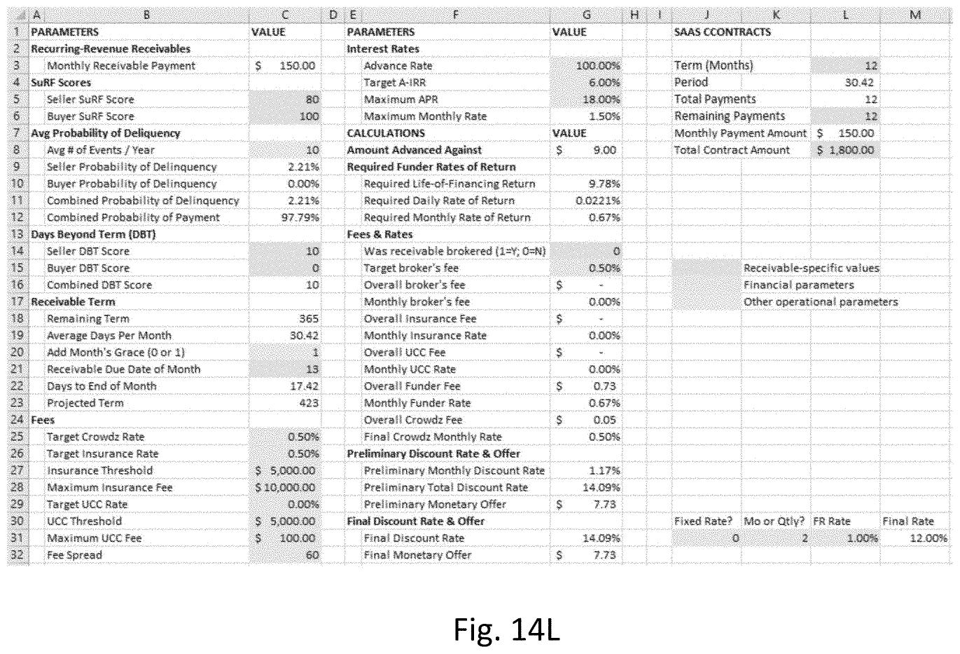

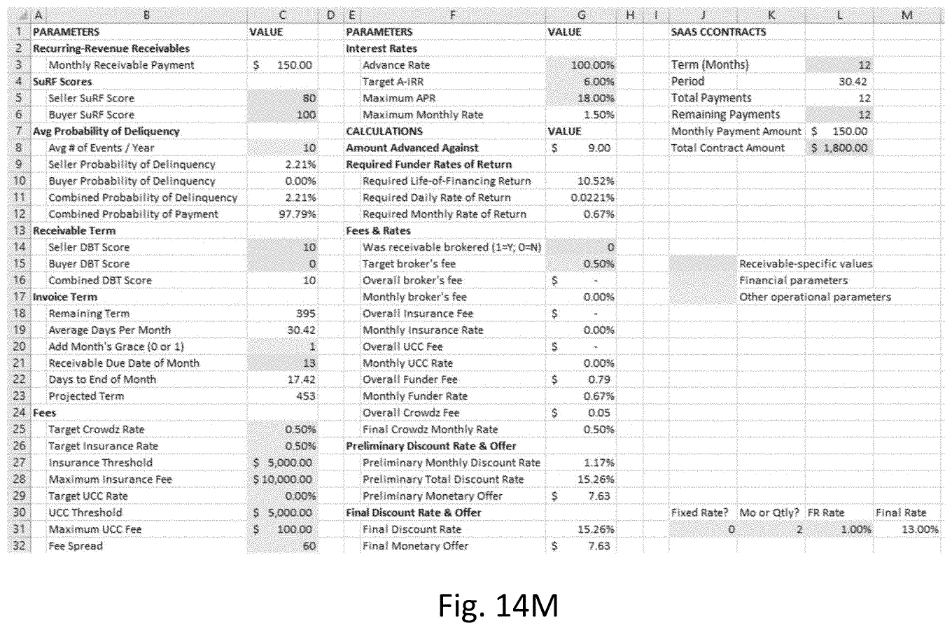

The discount rate and offer determination process for recurring receivables is described in greater detail below with respect to the spreadsheets shown in FIGS. 14A-14M. The cell numbers referenced in the section below reference the spreadsheets shown in FIGS. 14A-14M, which illustrate an example of applying the parameterized model to a recurring receivable for a 12 month contract. Note that there are thirteen spreadsheets and not 12 because the initial month is provided as a grace period.

Recurring Receivable Discount Rate and Offer Determination (Pricing)

Once recurring-revenue receivables are uploaded, they are automatically assigned a discount rate and offer price. The process is similar to that employed for invoices, as described in the “Discount Rates & Offers—Invoices” spec in The Invoice Pricing section, with the changes described below. Please see the attached spreadsheet (FIG. 14A) for the specific calculations. Note that a separate set of calculations is performed for each recurring-revenue receivable, using Funder parameters.

Remove Disqualified Recurring-Revenue Receivables

Before recurring-revenue receivables are scored, the system automatically removes those that do not meet the Funder's specific qualifications, as enumerated in the “Funder Parameters” spec in The Funder Parameters section (note: funding-limit restrictions are discussed in the “Funding Limit & Auto-Funding” spec in The Funding Limit and Auto-Funding section). Specifically:

a. Maximum receivable amount. The recurring-revenue receivable's value exceeds the maximum value of any one receivable, if a maximum value has been set (item d in the “Funder Parameters” spec in The Funder Parameters section).

b. Minimum acceptable SuRF Scores. The recurring-revenue receivable fails to meet the minimum SuRF Score for one or more of the Seller, the Buyer, and the combined receivable scores, if the relevant values have been set (item j).

c. Minimum remaining term for receivables. The recurring-revenue receivable fails to meet the minimum remaining term for receivables, if a minimum value has been set (item k).

d. Maximum remaining term for receivables. The recurring-revenue receivable exceeds the maximum remaining term for receivables, if a maximum value has been set (item 1).

e. Bankruptcy experiences. There are either too many bankruptcies on record for the Seller and/or the most recent bankruptcy is too recent (item m).

f. UCC experiences. There are either too many UC reports on record for the Seller and/or the most recent UCC report is too recent (item n).

g. Minimum acceptable bond rating for Sellers and/or Buyers. Either the Seller and/or the Buyer of the invoice, if it has a bond rating, has a bond rating that falls below the minimum, if the relevant values have been set (item o).

h. Acceptable industries. The Seller does not belong to an industry on the Funder's acceptable-industries list (item p).

i. Acceptable geographies. The Seller is not located in a geographical area on the Funder's acceptable-geographies list (item q).

j. Minimum acceptable sustainability score. The Seller's sustainability score does not meet the minimum acceptable sustainability score, if a minimum has been set, or else it does not possess a sustainability score, if one is required (item r).

Note: Some of the above constraints will have different values for invoices and recurring-revenue receivables; in cases in which the values differ, for this The Recurring Revenue Pricing section spec, make sure to use the value for recurring-revenue receivables.

Disqualified receivables from a given funding environment flow into the nearest downstream funding environment for processing, once implemented (see description in “Funding Limits & Auto-Funding” spec in The Funding Limit and Auto-Funding section).

Setup for the Automated Calculation:

If the Funder has chosen a fixed discount rate (item fin the “Funder Parameters” spec in The Funder Parameters section), proceed to the “Fixed Rate” section below. Note: The cell references below refer to cells in the attached spreadsheet (FIG. 14A). The following variables are largely the same as in the “Discount Rates & Offers—Invoices” spec in The Invoice Pricing section, except as indicated.

k. Receivable amount (Cell C3). The total receivable amount (face value) is derived directly from the data for the receivable in question.

l. SuRF Scores (Cells C5 & C6). The SuRF Scores are derived directly from the data for the receivable in question.
The Seller's SuRF Score (Cell C5) is already known upon the Seller's registration, either currently or previously.
The Buyer's SuRF Score (Cell C6) also may be known if the Buyer is already listed in the system; otherwise, the Buyer's SuRF Score is calculated in real-time in the usual fashion.
If the Buyer's SuRF Score cannot be calculated (due to a lack of information), the Buyer's SuRF Score is assumed, for the purpose of this calculation, to be 90.
Note: this default SuRF Score of 90 is not posted in the Administrator database as the Buyer's SuRF Score, which is listed as “TBD” if no other information is available; however, the default SuRF Score of 90 is used for the purpose of calculating the discount rate and offer.
If there are multiple results from the database calls for either the Seller, the Buyer, or both, calculations cannot proceed until the Seller selects a company name from the options.

m. Average probability of delinquency (Cells C8 to C12). There are a number of factors used to calculate the average probability of delinquency for the Sellers and Buyers:
Average number of events per year (Cell C8). A parameter used in calculating the delinquency probabilities, entered on the Administrator Parameters screen.
Seller probability of delinquency (Cell C9). Calculated as: 1−EXP(LN((C5/100)/C8). Note: variables in equation refer to the cell number in the spreadsheet, e.g., C5=the value in Cell C5.
Buyer probability of delinquency (Cell C10). Calculated as: 1−EXP(LN((C6/100)/C8).
Combined probability of delinquency (Cell C11). Calculated as: 1−((1−C9)*(1−C10)).
Combined probability of payment (Cell C12). Calculated as: 1−C11.

n. Days Beyond Term (DBT) Scores (Cells C14 to C16). Days beyond term are the projected number of days by which the party will be late in paying/repaying (beyond the respective due date).
The Seller's DBT Score (Cell C14) is already known upon the Seller's registration, either currently or previously.
The Buyer's DBT Score (Cell C15) also may be known if the Buyer is already listed in the system; otherwise, the Buyer's DBT Score is calculated in real-time in the usual fashion.
If the Buyer's DBT Score cannot be calculated (due to a lack of information), the Buyer's DBT Score is assumed, for the purpose of this calculation, to be 0.
Note: this default DBT Score of 0 is not posted in the Administrator database as the Buyer's DBT Score, which is listed as “TBD” if no other information is available; however, the default DBT Score of 0 is used for the purpose of calculating the discount rate and offer.
If there are multiple results from the database calls for either the Seller, the Buyer, or both, calculations cannot proceed until the Seller selects a company name from the options.
The Combined DBT Score (Cell C16) is calculated as: C14+C15.

o. Receivable-installment term (Cells C18 to C23). The receivable term is the projected time (in days) from the date of receivable financing (purchase) to the date on which the financing for each installment is expected to be repaid. Note that there are different values of each of the variables in this section, associated with each spreadsheet (FIG. 14B, FIG. 14C, . . . , FIG. 14M), representing the nth payment on the receivable and hence the nth repayment of the receivable financing. The calculation of each individual payment/repayment uses the following factors:
Remaining term (Cell C18). This is the number of days left in until the nth payment is supposed to be paid, as drawn from the receivable data.
Average days per month (Cell C19). This is calculated as 365/12.
Add end-of-month's grace period (0 or 1) (Cell C20). This is a factor, entered on the Funder Parameters screen (as described in the “Funder Parameters” spec, item i. in The Funder Parameters section) that indicates whether the Funder is willing to give the Seller until the end of the month in which repayment is due in order to repay the funding. If so, then the Seller is able to take advantage of the consolidated repayments option (see the “Consolidated Repayments” spec in The Consolidated Repayments section). An incremental, time-based discount fee is charged for this privilege.
Add Month's Grace (0 or 1) (Cell D20). This is a factor, entered on the Funder Parameters screen (as described in the “Funder Parameters” spec, item i, in The Funder Parameters section) that indicates whether the Funder is willing to give the Seller an additional month beyond the end of the month in which repayment is due in order to repay the funding. If so, then the Seller is able to take advantage of the consolidated repayments option (see the “Consolidated Repayments” spec in The Consolidated Repayments section). An incremental, time-based discount fee is charged for this privilege.
Receivable due date of month (Cell C21). This is the day of the month on which each repayment is due.
Days to end of month (Cell C22). This is calculated as C19-C21.
Projected term (Cell C23). This is the projected time from the date of the receivable financing to the date on which the portion of the financing for the nth installment of the recurring-revenue receivable is expected to be repaid, and is defined as the “receivable-installment term,” as stated above. It is calculated as: C18+C16+(C22*C20)+(C19*D20).

p. Fees (Cells C25 to C32). These variables are drawn from the Administrator Parameters Screen for the given deployment, unless the modifiable values are modified by variables drawn from the Funder Parameters Screen. These fees are drawn from the “Funder Parameters” spec, items s & t, in The Funder Parameters section, as modified & augmented by the “Administrator Parameters” spec, items t through dd, in the Administrator Parameters section).

q. Advance & interest rates (Cells G3 to G6). The interest rates involved in the discount rate and offer calculations are determined as follows:
Advance rate (Cell G3). The percentage of the value of the receivable that Administrator or the Funder is willing to fund against. (See the “Funder Parameters” spec, item h, in The Funder Parameters section.)
Target A-IRR (Cell G4). Administrator or the Funder's target A-IRR (annualized internal rate of return) is extracted from the Administrator or the Funder's Parameters Screens, depending upon which governs. The Target A-IRR may vary from Funder to Funder (i.e., from deployment to deployment). (See the “Funder Parameters” spec, item e, in The Funder Parameters section.)
Maximum APR (Cell G5). Administrator or the Funder's maximum APR (annual percentage rate) is the maximum annualized interest that Sellers within a given deployment may be charged. The variable is extracted from the Administrator or the Funder's Parameters Screens, depending upon which governs. The Maximum APR may vary from Funder to Funder (i.e., from deployment to deployment). (See the “Funder Parameters” spec, item g, in The Funder Parameters section.)
Maximum monthly rate (Cell G6). This value is calculated as: G4/12.

r. Fixed-rate parameters (Cells J31 to M31). These parameters set forth the discount rate to apply if a fixed rate rather than a variable rate is chosen.
Fixed Rate? (Cell J31). Whether or not a fixed rate has been chosen, with “1” indicating that it has and “0” indicating that it has not. (See the “Funder Parameters” spec, item f, The Funder Parameters section.)
Mo or Qtly? (Cell K31). Whether the fixed rate is a monthly (value of “2”). Quarterly (value of “1”, or per-receivable (value of “0”) rate. (See the “Funder Parameters” spec, item f, in The Funder Parameters section.)
FR Rate (Cell L31). The rate chosen as the fixed rate, as a percent, regardless of whether it is a monthly rate or an annual rate. (See the “Funder Parameters” spec, item f, in The Funder Parameters section.)
Final rate (Cell M31). The total discount rate for the receivable, taking into account the chosen rate and whether or not it is a monthly, quarterly, or an per-receivable rate. If a fixed rate has been chosen, this value feeds into the discount-rate cell (Cell G31) and thereupon determined the monetary offer (Cell M32).

s. Additional parameters (Cells L3 to L8). There are six additional parameters for the recurring-revenue receivables that are not used for invoices:
Term (Months) (Cell L3). The total length of the SaaS contract, in months, drawn from the SaaS contract data.
Period (Cell L4). The average number of days per months, calculated as: 365/12.
Total payments (Cell L5). The total number of payments for the SaaS contract, drawn from the SaaS contract data (this figure will be equal to the term for 12-month SaaS contracts with monthly payments).
Remaining payments (Cell L6). The number of payments remaining on the contract—that is, the number of payments the customer has yet to make to the Seller—drawn from the SaaS contract data.

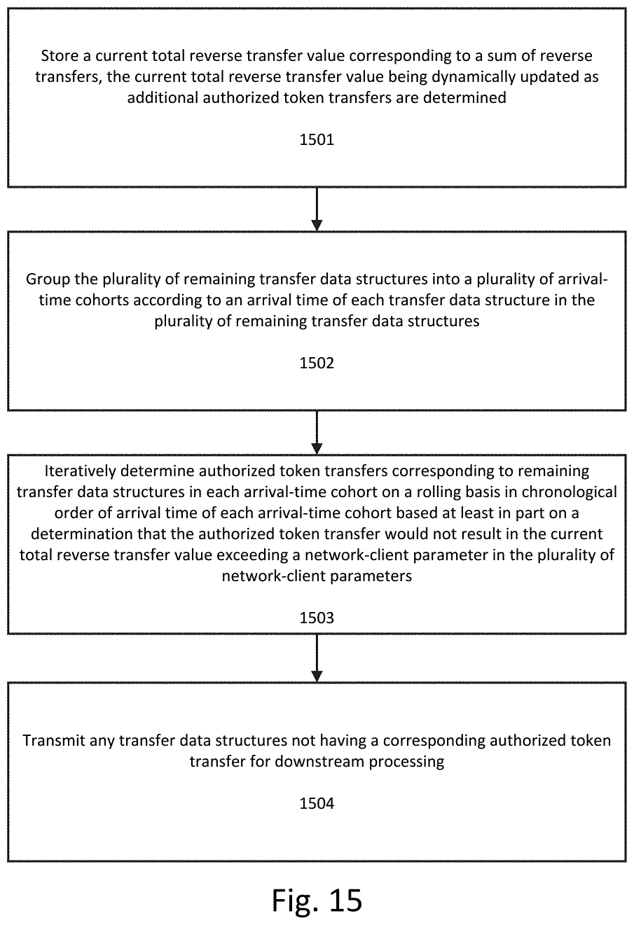

Once the pricing (i.e., the discount rate determination and offer determination) of all non-disqualified/removed receivables is performed, it is necessary to determine which offers the funder wishes to approve. Since the offer determination process is automatic, it is necessary for the funder to specify funding limits and preferences in order to ensure that they do not commit to funding that exceeds their available capital. These funding limits and preferences can be used to determine which offers to approve from a pool of available offer. This process is shown in FIG. 15, which illustrates a flowchart for another aspect of applying the parameterized pricing model to the plurality of remaining receivables to determine a plurality of discount rates and a plurality of approved offers corresponding to a plurality of approved receivables in the plurality of receivables according to an exemplary embodiment.

At step 1501 a current total reverse transfer value is stored corresponding to a sum of reverse transfers, the current total reverse transfer value being dynamically updated as additional authorized token transfers are determined.

In the invoice/receivable based funding context, a current total offer value corresponding to a sum of approved offers is stored, the current total offer value being dynamically updated as additional offers are approved.

At step 1501 the plurality of remaining transfer data structures are grouped into a plurality of arrival-time cohorts according to an arrival time of each transfer data structure in the plurality of remaining transfer data structures.

In the invoice/receivable based funding context, the plurality of remaining receivables are grouped into a plurality of arrival-time cohorts according to an arrival time of each receivable in the plurality of remaining receivables.

At step 1503 authorized token transfers corresponding to remaining transfer data structures in each arrival-time cohort are iteratively determined on a rolling basis in chronological order of arrival time of each arrival-time cohort based at least in part on a determination that the authorized token transfer would not result in the current total reverse transfer value exceeding a network-client parameter in the plurality of network-client parameters

In the invoice/receivable based funding context, offers corresponding to remaining receivables in each arrival-time cohort are iteratively approved on a rolling basis in chronological order of arrival time of each arrival-time cohort based at least in part on a determination that approval would not result in the current total offer value exceeding a funder limit parameter in the plurality of funder parameters.

Additionally, at step 1504 any transfer data structures not having a corresponding authorized token transfer are transmitted for downstream processing.

In the invoice/receivable based funding context, any unapproved offers are transmitted for downstream processing, described further below.

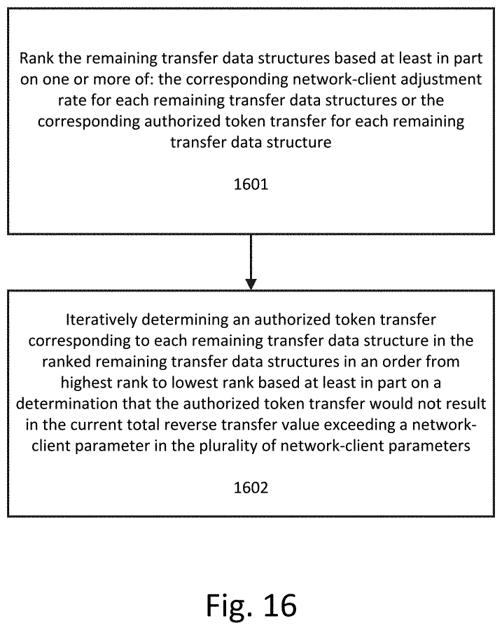

FIG. 16 illustrates a flowchart for iteratively determining authorized token transfers corresponding to remaining transfer data structures in each arrival-time cohort on a rolling basis in chronological order of arrival time of each arrival-time cohort based at least in part on a determination that the authorized token transfer would not result in the current total reverse transfer value exceeding a network-client parameter in the plurality of network-client parameters.

In the invoice/receivable based funding context, this process is used for iteratively approving offers corresponding to remaining receivables in each arrival-time cohort on a rolling basis in chronological order of arrival time of each arrival-time cohort based at least in part on a determination that approval would not cause the current total offer value to exceed a funder limit parameter in the plurality of funder parameters according to an exemplary embodiment. The process shown in FIG. 16 is performed for each arrival-time cohort (i.e., offers corresponding to remaining receivables within that cohort).

At step 1601 the remaining transfer data structures are ranked based at least in part on one or more of: the corresponding network-client adjustment rate for each remaining transfer data structures or the corresponding authorized token transfer for each remaining transfer data structure.

In the invoice/receivable based funding context, the remaining receivables are ranked based at least in part on one or more of: the corresponding discount rate for each remaining receivable or the corresponding offer for each remaining receivable.

Additionally, at step 1602 an authorized token transfer corresponding to each remaining transfer data structure in the ranked remaining transfer data structures is iteratively determined in an order from highest rank to lowest rank based at least in part on a determination that the authorized token transfer would not result in the current total reverse transfer value exceeding a network-client parameter in the plurality of network-client parameters.

In the invoice/receivable based funding context, each offer corresponding to each remaining receivable in the ranked remaining receivables is iteratively approved in an order from highest rank to lowest rank based at least in part on a determination that approval would not result in the current total offer value exceeding a funder limit parameter in the plurality of funder parameters.

With respect to the invoice/receivable based funding context, the steps described in FIGS. 15-16 are explained in greater detail below in the section on funding limits, auto-funding, and approval.

Funding Limits, Auto-Funding, and Approval

Once disqualified receivables have been excluded and the remaining receivables have been auto-priced (described in the “Discount Rates & Offers” sections for invoices and recurring-revenue receivables, respectively), candidate receivables are automatically evaluated for funding in real-time as they emerge from auto-pricing, according to the following processes:

Receivables-Staging

Receivables (including invoices, recurring-revenue receivables, and any other future receivable types) are automatically routed to the appropriate “Receivables Staging Area” (RSA), as follows:

Single-Funder environments. Receivables either uploaded into Funder A's funding deployment or flowing into Funder A's funding environment from an upstream funding environment are loaded into Funder A's staging area, in order of arrival.

Multi-Funder environments. Receivables either uploaded into Multi-Funder Environment B or flowing into Multi-Funder Environment B from an up from an upstream funding environment are loaded into Multi-Funder Environment B's staging area, in order of arrival.

The processing of receivables within these two types of funding environments differ somewhat, and so will be considered separately.

Receivables-Ranking

Receivables in single-Funder environment are considered in the order in which they arrived (called a “arrival-time cohort,” or ATC), and within each ATC are automatically ranked, as follows:

Discount-rate ranking. Receivables (all receivable types evaluated together) are ranked according to discount rate, lowest to highest.

Discount-rate grouping. All discount rates are rounded to the nearest 0.1%, and receivables are placed into discount-rate groupings according to discount rate, from lowest to highest.

Monetary-offer ranking. Within each discount-rate grouping, receivables (all receivable types evaluated together) are ranked according to final monetary offer (Cell C32, FIG. 13, for invoices, and Cell R32, FIG. 14A for recurring-revenue receivables), from lowest to highest.

Receivables-Approval

Once ranked as above, receivables are automatically approved for funding for a given Funder, as follows:

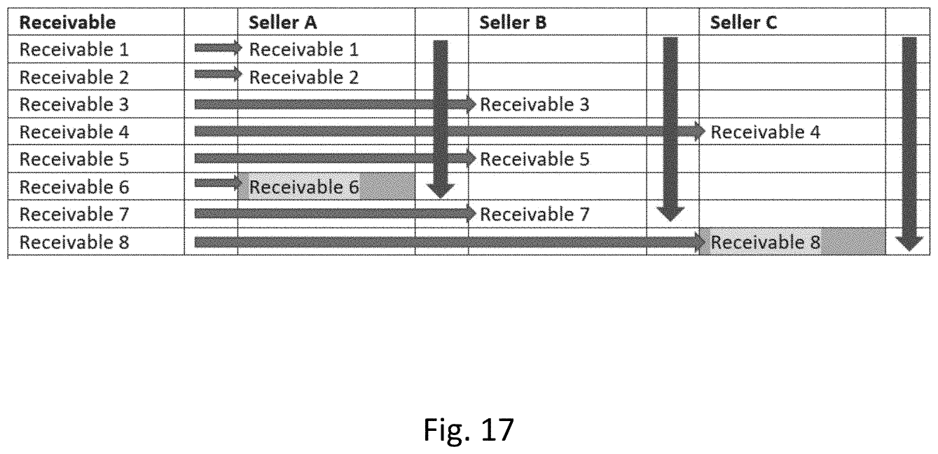

Seller array. Keeping receivables within the ATC in lowest-to-highest rank order, as just described, receivables are fanned out (blue arrows) into individual columns by Seller, as shown in FIG. 17. Note that the vertical arrows in FIGS. 17-19 indicated the order in which receivables are considered for funding.

Seller funding limits. Going down the list for each Seller, receivables are auto-approved for continued consideration as long as the total monetary offers remain under the Funder's current funding limit for each individual Seller, with that limit determined as follows: Funder's total funding limit for that Seller, less the amount of the Funder's funding outstanding for that Seller=current funding limit for that Seller). If the Funder has imposed no funding limit for a given Seller, then all receivables associated with that Seller are approved for continued consideration.

Routing downstream. Receivables whose monetary offer would exceed the Funder's current funding limit for the Seller in question (highlighted yellow) are routed downstream to the next funding environment (routing downstream is discussed later in this spec).

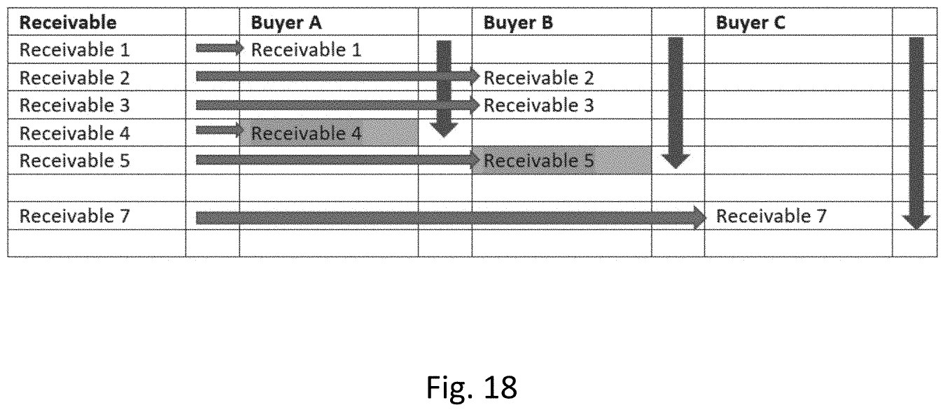

Buyer array. All receivables auto-approved for continued consideration above in the Seller array are rank-ordered in a similar Buyer array in the same manner, as shown in FIG. 18

Buyer funding limits. Going down the list for each Buyer—in a manner similar to that performed for Sellers—receivables are auto-approved for continued consideration as long as the total monetary offers remain under the Funder's current funding limit for each individual Buyer, with that limit determined as follows: Funder's total funding limit for that Buyer, less the amount of the Funder's funding outstanding for that Buyer=current funding limit for that Buyer). If the Funder has imposed no funding limit for a given Buyer, then all receivables associated with that Seller are approved for continued consideration.

Routing downstream. Receivables whose monetary offer would exceed the Funder's current funding limit for the Buyer in question (highlighted green) are routed downstream to the next funding environment (routing downstream is discussed later in this spec).

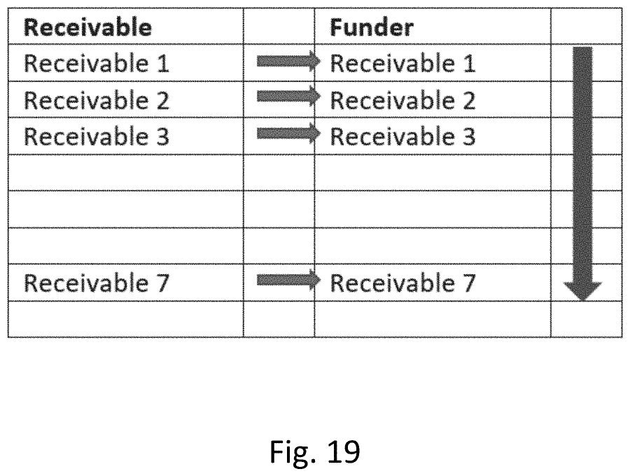

Funder array. All receivables auto-approved for continued consideration above in the Buyer array are rank-ordered in a Funder array in the same manner, as shown in FIG. 19.

Funder funding limits. Going down the overall list, receivables are auto-approved for funding as long as the total monetary offers remain under the Funder's current funding limit, with that limit determined as follows: Funder's total funding limit, less amount of the Funder's funding outstanding=Funder's current funding limit.

Routing downstream. Receivables whose monetary offer would exceed the Funder's current funding limit (highlighted magenta) are routed downstream to the next funding environment (routing downstream is discussed later in this spec).

Offers to Sellers

For all receivables for which the funding is auto-approved, the respective Sellers receive the accepted offer on their Receivables screen. Note that, because all of the above actions take place almost instantaneously, Sellers should receive offers in cases in which funding is auto-approved within a few seconds of the receivables' posting.

Receivables-Funding & Funding Holds

Receivables that pass all three gates above are auto-approved for funding, and a temporary hold is placed on that funding amount.

Auto-sell. If the Seller in question has auto-sell turned on, the funding for the approved receivables is executed, and the funding hold is removed.

Manual sell. If the Seller in question does not have auto-sell turned on, then the Seller has 72 hours to approve the presented offer. If the offer is approved, the Funder auto-funds. If the offer is not approved, the offer is withdrawn, and the receivable cannot be sold.

Routing Downstream

For receivables that are not accepted for funding and hence routed downstream, they are injected into the receivables staging area for the immediately downstream funding environment.

Downstream environments. For instance, a receivable routed downstream from a white-label deployment subsequently may be injected into the Administrator self-funding environment or the Administrator SPV. Receivables not approved for funding within these environments thereupon may be routed downstream to the Secondary Market. And so on.

Identical processes. The identical processes are followed in each downstream funding environment.

Queuing

Receivables that do not receive an offer at the funding environment further downstream (e.g., the Secondary Market) are routed back upstream to their original funding environment, where they move to the head of the queue in the respective receivables staging area.

Recycling through funding stream. If receivables are not funded by their home funding environment, they are recycled through the funding stream every 15 minutes.

Removal from queue. Receivables are removed from the RSA queue when they: (1) fall below the minimum term; (2) are removed from the queue (i.e., from the Receivables Screen) by the Seller; or (3) have been partially or fully paid by the Buyer. In all of these cases, receivables further down in a funding environment's queue move ahead.

Clearing Cap Space

Funding limits are based on the difference between the established funding limit, if any, and the amount of funding outstanding (for a given Seller, for a given Buyer, or overall). Funding cap space is cleared in one of two ways:

Increased funding limits. The Funder increases its funding limits overall, or for individual Sellers and/or Buyers.

Reduced funding outstanding. Receivables funding is repaid (in whole or in part), or outstanding funding is written off.

Note: If a Funder reduces one or more funding limits, it reduces or eliminates cap space, but it doesn't affect funding that has already been disbursed. However, if cap space becomes negative, funding will not resume until positive cap space has been cleared.

Multi-Funder Environments

In multi-Funder environments, the above processes are performed for each Funder in the multi-Funder environment. There are four possible results in this circumstance.

Exactly one Funder can make an offer. This offer is presented to the Seller on its Receivables Screen.

Multiple Funders can make an offer, and there is a “best” offer. The best offer (highest monetary offer and lowest discount rate) is automatically presented to the Seller on its Receivables Screen.

Multiple Funders can make an offer, with multiple “best” offers. The offer to the Seller is randomly chosen among the equal “best” offers.

No Funder can make an offer. The receivable proceeds downstream (or back upstream to the receivables home environment if the Multi-Funder environment in question is the furthest downstream.

Setting Seller Viewing Parameters

Once the receivables-ranking is completed, all approved receivables are presented to the Seller as a group, with these calculated values:

Total receivables value: the sum of the receivables amounts for all approved receivables.

Total offer value: the sum of the offer amounts for all approved receivables.

Average discount rate: [1−(Total offer value/Total receivables value)], expressed as a 2-decimal percentage.

Once these values are presented, the Seller can filter the receivables in the “Approved” list by using these five parameters:

Buyers: The Buyers list represents the list of all Buyers whose receivables the Seller wants to sell. The Buyers list includes a list of all Buyers in the “Approved” list, presented in alphabetical order, with “All Buyers” at the top of the list and checked by default. Clicking a Buyer unchecks “All Buyers.” Clicking a selected Buyer deselects the Buyer. Selecting “All Buyers” unchecks all individual Buyers.

Minimum Term: The minimum term is the minimum term of receivables that the Seller wants to sell. The minimum term (whole numbers, with days for invoices and months for recurring-revenue receivables) ranges from the minimum term in the Funder's parameters, or “0” if the Funder has not set a minimum, to the Funder's maximum term, or is without limit if the Funder did not select a maximum. The minimum term selected cannot exceed the selected maximum Term, if one has been selected. If a maximum term has been selected, the upper bound of the minimum term equals the selected maximum term. As with the Funder parameters, there are separate scales for invoices and recurring-revenue receivables.

Maximum Term: The maximum term is the maximum term of receivables that the Seller wants to sell. The maximum term (whole numbers, with days for invoices and months for recurring-revenue receivables) ranges from the minimum term in the Funder's parameters, or “0” if the Funder has not set a maximum, to the Funder's maximum term, or is without limit if the Funder did not select a maximum. The maximum term selected cannot be less than the selected minimum Term, if one has been selected. If a minimum term has been selected, the lower bound of the maximum term equals the selected minimum term. As with the Funder parameters, there are separate scales for invoices and recurring-revenue receivables.

Maximum Discount Rate: The discount rate is the maximum value of the discount rate the Seller will accept. It ranges between 0.00% and the highest discount rate in the approved invoice pool.

Seller Cap: The Seller cap is the total amount of monetary offers for receivables that the Seller wants to sell. The range is from 0.00 (in monetary value) to the maximum of the total current funding limit for that Seller, which is equal to the Funder's overall funding limit less any outstanding funding that the Seller has from the Funder.

Note: These limits apply differently to multi-Funder environments. For multi-Funder facilities (e.g., a white-label with two Funders), the minima (term) are the lesser of the maxima set by the Funders and the maxima (term, discount rate, Seller cap) are the greater of the maxima set by the Funders. For the secondary market, the same principles apply, but considered only those Funders represented in the “Approved” receivables pool.

Selecting Receivables to Sell

When the Seller adjusts the parameter settings and clicks to “Refresh,” the list of receivables (and the total value and discount rate thereof) changes according to the parameter settings. The first four parameters (i.e., excluding Seller cap) act as delimiting filters—that is, they remove receivables that do not comply with the filters sent.

For instance, assume that, in the pool of Approved invoices, the following applies:

Buyers: Receivables represent Buyer A through Buyer J.

Minimum term: The minimum term of the invoices is 15 days.

Maximum term: The maximum term of the invoices is 120 days.

Maximum discount rate: The discount rate ranges up to 10%.

Next, assume that the Seller sets the following parameters:

Buyers: Buyer B through Buyer I.

Minimum term: 30 days.

Maximum term: 90 days.

Maximum discount rate: 5.00%.

In this case, invoices from Buyers A and J, those with terms from 15 to 29 days and from 91 to 120 days, and those with discount rates greater than 5.00% are excluded from the “Approved” pool. These filters are applied separately. For example, an invoice from Buyer B with a term of 60 days (compliant with the first three parameters) still would be excluded if its discount rate were greater than 5.00%.

The Seller cap is applied following the above exclusions. To apply the Seller cap, the remaining receivables are considered in order of funding amount, from lowest to highest.

If the total offer value of the remaining receivables is below the Seller cap, all remaining receivables stay in the modified “Approved” receivables pool.

If the total offer value of the remaining receivables is above the Seller cap, the receivables with the highest offer value are removed, one-by-one, until the total funding values of the remaining receivables falls to or below the Sellers cap.

Each time the Seller clicks “Refresh,” the total receivables value, total offer value, and average discount rate are recalculated—as described above—and displayed.

Removed Receivables

Receivables that are removed from the “Approved” receivables pool, as described above, are placed at the top of the Queue, in order of discount value (lowest first), and then, for each discount range (as previously defined) in order of offer value (lowest first).

As the Seller parameters are changed to be more inclusive, receivables are pulled back into the “Approved” receivables pool, up to the Funder limits (i.e., if nothing else changes and the original Seller parameters are restored, all previously-approved receivables return to the “Approved” receivables pool.

If at least some of the originally approved receivables remain in the queue, they are the first to return (in their order in the queue) to the “Approved” pool if cap space is cleared for the Seller (i.e., if the Seller's outstanding funding amount, such as through repayments, falls below the Seller Cap).

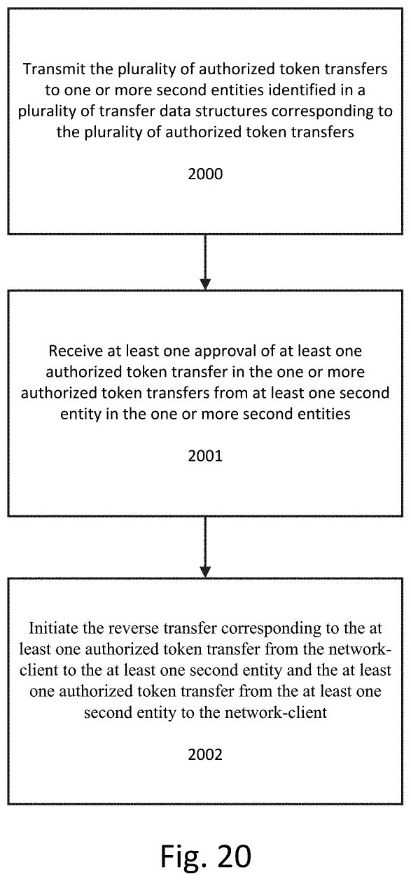

After selection of approved offers, it is necessary to execute the necessary communications and transactions to complete the funding. FIG. 20 illustrates a flowchart for completing transfers according to an exemplary embodiment. In the receivable/invoice based funding context, this process can be used to complete funding transactions with sellers according to an exemplary embodiment.

At step 2000 the plurality of authorized token transfers are transmitted to one or more second entities identified in a plurality of transfer data structures corresponding to the plurality of authorized token transfers.

In the receivable/invoice based funding context, the plurality of approved offers are transmitted to one or more sellers corresponding to the one or more receivables.

At step 2001 at least one approval of at least one authorized token transfer in the one or more authorized token transfers is received from at least one second entity in the one or more second entities.

In the receivable/invoice based funding context, at least one acceptance of at least one approved offer in the one or more offers is received from at least one seller in the one or more sellers.

At step 2002 the reverse transfer corresponding to the at least one authorized token transfer from the network-client to the at least one second entity and the at least one authorized token transfer from the at least one second entity to the network-client are initiated.

In the receivable/invoice based funding context, a transfer of funds is initiated corresponding to the at least one approved offer from the funder to the at least one seller and NFTs corresponding to collection privileges for the corresponding receivables are transferred from the seller to the funder.

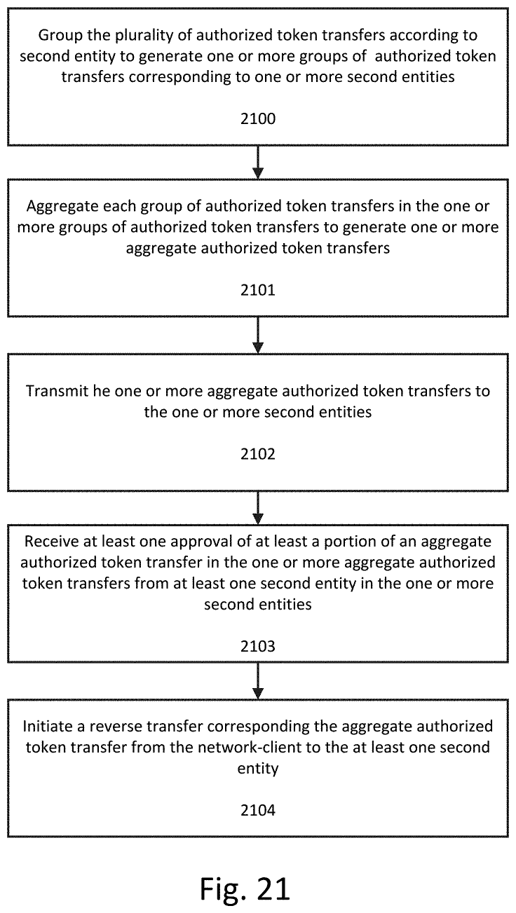

FIG. 21 illustrates a flowchart for completing transfers in an aggregated manner according to an exemplary embodiment.

In the receivable/invoice based funding context, the approved offers can also be aggregated on a per-seller basis and communicated to sellers in an aggregate format and the steps of the flowchart can be used to complete the funding transactions with sellers for aggregate offers.

At step 2101 the plurality of authorized token transfers are grouped according to second entity to generate one or more groups of authorized token transfers corresponding to one or more second entities.

In the receivable/invoice based funding context, the plurality of approved offers are grouped according to seller to generate one or more groups of approved offers corresponding to one or more sellers.

At step 2102 each group of authorized token transfers in the one or more groups of authorized token transfers is aggregated to generate one or more aggregate authorized token transfers.

In the receivable/invoice based funding context, each group of approved offers in the one or more groups of offers is aggregated to generate an aggregate offer.

At step 2103 the one or more aggregate authorized token transfers are transmitted to the one or more second entities.

In the receivable/invoice based funding context, the one or more aggregate offers are transmitted to the one or more sellers. Although a aggregate offer is transmitted, the individual offer information is also included so that the seller can view of the offers that contribute to the aggregate and optionally select a subset of offers to accept.

At step 2104 at least one approval of at least a portion of an aggregate authorized token transfer in the one or more aggregate authorized token transfers is received from at least one second entity in the one or more second entities.

In the receivable/invoice based funding context, receiving at least one acceptance of at least a portion of an aggregate offer in the one or more aggregate offers from at least one seller in the one or more sellers; and

At step 2105 a reverse transfer is initiated corresponding the aggregate authorized token transfer from the network-client to the at least one second entity.

In the receivable/invoice based funding context, a transfer of funds is initiated corresponding to the at least one aggregate offer from the funder to the at least one seller.

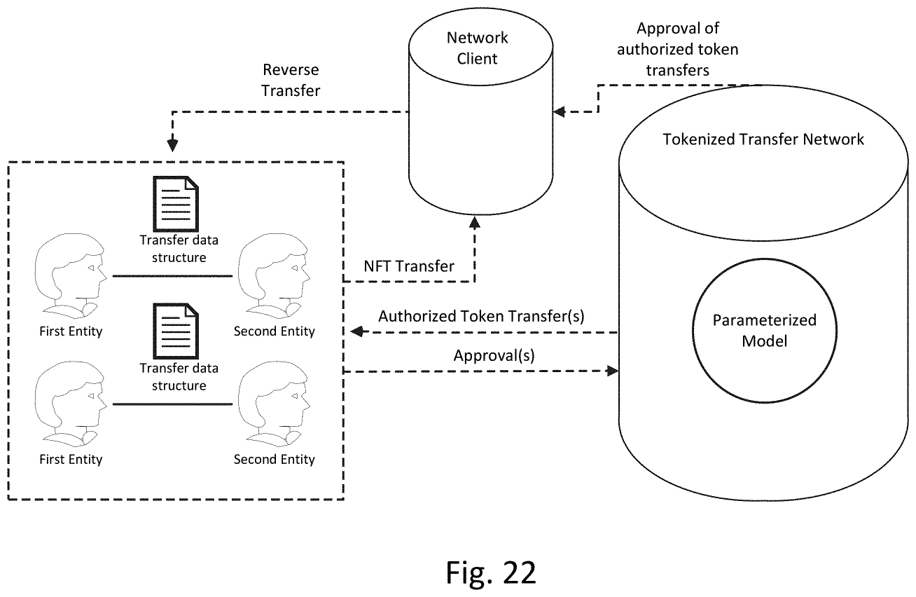

FIG. 22 illustrates a system chart of the overall transfer process after approval. As shown in FIG. 22, authorized token transfers are communicate to first/second entities. Although shown as being directly communicated, it is understood that these offers can be communicated through the network client. Approvals are then received at the platform from first/second entities (either directly or via network clients). The network client is then notified of approvals, a reverse transfer is initiated from the network client to the first/second entities, and an NFT transfer is initiated from the first/second entities to the network client.

In the receivable/invoice based funding context, the system chart can correspond to the overall funding process after offer approval. In this case, offer(s) are communicate to sellers. Although shown as being directly communicated, it is understood that these offers can be communicated through the funder. Acceptance(s) are then received at the platform from sellers/buyers (either directly or via funders). The funder is then notified of accepted offers and the funding is transmitted from funders to the accepting sellers. Additionally, an NFT transfer is initiated from the sellers/buyers to the funders, as discussed above.

As explained in the previous section, the seller can filter and view the received offers in a variety of ways prior to determining which offers to accept. The seller can choose to accept aggregate offers, accept individual offers, or accept portions of aggregate offers.

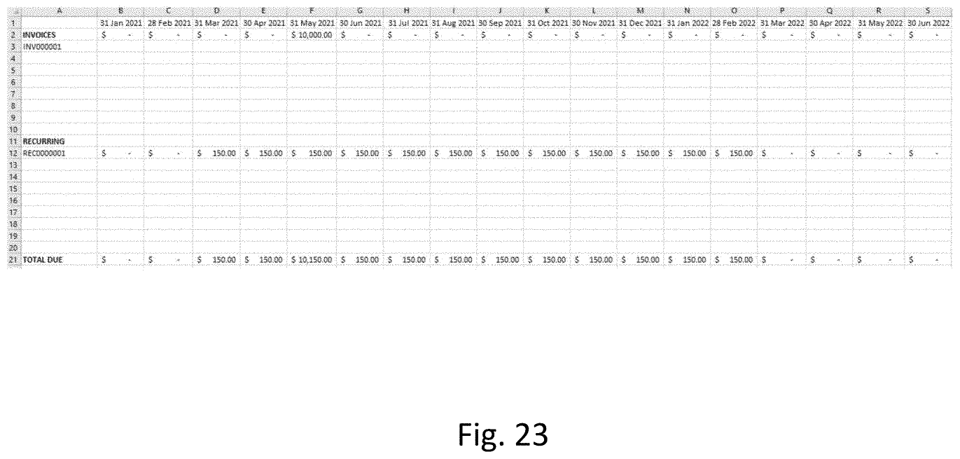

Once funding is completed, it is contingent on the seller to pay the required funds back to the funder when they are received from the buyer. Alternatively, the buyer can pay the funder directly. The platform allows for consolidated repayments for each seller so that they do not need to pay the funder separately on a per-invoice or per-receivable basis. The consolidated repayments structure is described in greater detail below with reference to the spreadsheet shown in FIG. 23.

Consolidated Repayments

For receivable-funding events for which Cell C20=1 (in FIG. 13 or FIGS. 14A-14M), repayments by Sellers for funded receivables will be set up for maximum ease of use for the Seller, specifically:
One payment per month. Only one payment must be made per month (at the end of the month) for all balances due.
Billed in advance. If Cell D20=1 (in FIG. 13 or FIGS. 14A-14M), the payment is billed one month in advance to enable the Seller to plan for what must be repaid.
Single account. All payments are made to a single account, which automatically distributes the repayments to the payees (until this can be accomplished, there will be separate billings for each Funder).
Automated reconciliation. Automated reconciliation takes place, so that Sellers will not have to reconcile payments to receivables (to be implemented later).

Calculating Repayments Due

The repayment schedule for an illustrative Seller is shown in FIG. 23.
Separate sections. All invoices are listed in one section and all recurring-revenue receivables in the second section.
Samples shown. A single sample of each is shown.
Invoice repayments. The invoice repayments link to the respective invoice screens, a sample of which is shown in FIG. 13.
Recurring-revenue receivable repayments. The recurring-revenue receivable repayments link to the respective recurring-revenue receivables screens, a sample of which is shown in FIG. 14A.
Monthly totals due. The total due for each month is shown at the bottom of the screen.
Note: there will be a separate invoice screen for each funded invoice, and a separate set of recurring-revenue receivables screens for each funded recurring-revenue (SaaS) receivable.

The repayment schedule takes advantages of additional fields on the invoice and recurring-revenue receivables screens (formulae are embedded in the indicated cells, where relevant):
Receivable number (Cell C2) (in FIG. 13 or FIGS. 14A-14M). The receivable number is listed on Cell C2 in both FIG. 13 (for invoices) and FIG. 14A for recurring-revenue receivables.
Funded date (Cell J28 & J29) (in FIG. 13 or FIGS. 14A-14M). The funded date is provided in Cell J29 (for invoices) and Cell J28 (for recurring-revenue receivables) of the respective tabs.
Nominal first repayment due date (Cell K28 & K29) (in FIG. 13 or FIGS. 14A-14M). The nominal due date for the first repayment is provided in Cell K29 (for invoices) and Cell K28 (for recurring-revenue receivables) of the respective tabs.
Actual repayment term (Cell L28 & L29) (in FIG. 13 or FIGS. 14A-14M). The actual term of the first repayment (taking into account any grace periods) is shown in Cell L29 (for invoices) and Cell L28 (for recurring-revenue receivables) of the respective tabs.
Actual first repayment due date (Cell M28 & M29) (in FIG. 13 or FIGS. 14A-14M). The actual due date for the first repayment is provided in Cell M29 (for invoices, “first & only repayment”) and Cell M28 (for recurring-revenue receivables) of the respective tabs.
Actual last repayment due date (Cell N28) (in FIG. 13 or FIGS. 14A-14M). The actual due date for the last repayment is shown in Cell N28 in FIG. 14A. Note that there is no last repayment due date for invoices, since there is only one repayment to be made.

Note that although this application frequently describes seller led deployments, buyer led deployments can also be used. Seller-led deployments are deployments in which the Seller registers and sells invoices that it has sent to its Buyers (which generally do not participate in the deployment). Buyer-led deployments are traditional supply-chain finance deployments in which it is the Buyer that registers, and then the Buyer brings its Sellers onboard and encourages its Sellers to upload invoices that the Buyer has sent them. The Buyer either provides the funding for the individual Sellers (if the Buyer is a large enterprise) or else the Buyer partners with a bank or investment house to do so. In this latter case, both Buyers and Sellers are registered on the system. In addition, in the Seller-led version, the Seller receives the funding it is usually the Seller that thereafter repays the funding after the Buyer has paid the invoices to the Seller. In the Buyer-led version, the Seller also receives the funding, but instead of paying the invoice, the Buyer pays the Funder directly (or pays itself, if the Buyer did the funding).

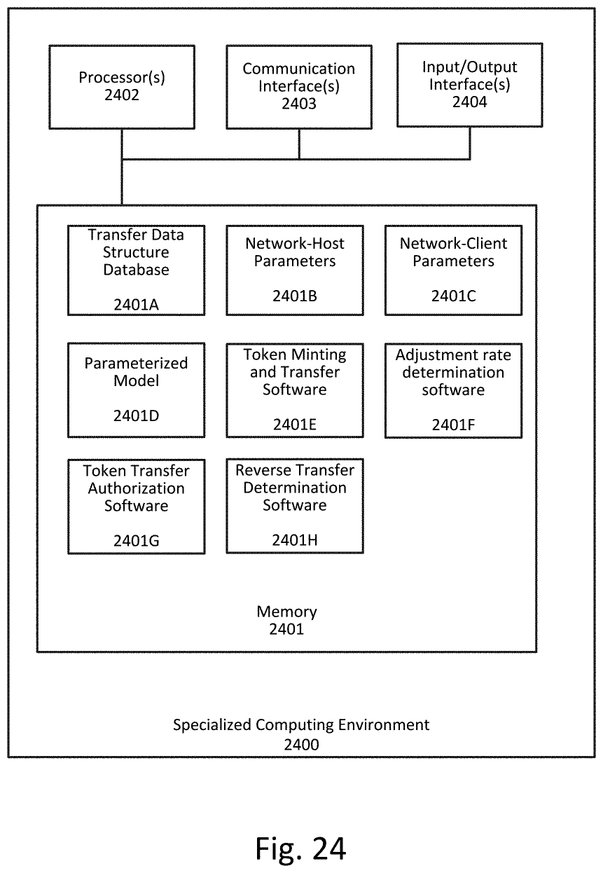

FIG. 24 illustrates the components of the specialized computing environment 2400 configured to perform the specialized processes described herein. Specialized computing environment 240 is a computing device that includes a memory 2401 that is a non-transitory computer-readable medium and can be volatile memory (e.g., registers, cache, RAM), non-volatile memory (e.g., ROM, EEPROM, flash memory, etc.), or some combination of the two.

As shown in FIG. 24, memory 2401 can include transfer data structure database 2401A, network-host parameters 2401B, network-client parameters 2401C, parameterized model 2401D, token minting and transfer software 2401E, adjustment rate determination software 2401F, token transfer authorization software 2401G, and reverse transfer determination software 2401, as well as any other components required to perform the methods described herein. Each of the software components in memory 2401 store specialized instructions and data structures configured to perform the corresponding functionality and techniques described herein.

All of the software stored within memory 2401 can be stored as a computer-readable instructions, that when executed by one or more processors 2402 (e.g., the controller), cause the processors (controller) to perform the functionality described with respect to FIGS. 1-23.

Processor(s) 2402 execute computer-executable instructions and can be a real or virtual processors. In a multi-processing system, multiple processors or multicore processors can be used to execute computer-executable instructions to increase processing power and/or to execute certain software in parallel. The processor(s) include a controller of the tokenized transfer network that coordinate/executes the above-described methods and steps.

Specialized computing environment 2400 additionally includes a communication interface 903, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 2400 further includes input and output interfaces 904 that allow users (such as system administrators) to provide input to the system to set parameters, to edit data stored in memory 2401, or to perform other administrative functions.

An interconnection mechanism (shown as a solid line in FIG. 24), such as a bus, controller, or network interconnects the components of the specialized computing environment 2400.

Input and output interfaces 2404 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 2400.

Specialized computing environment 2400 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 2400.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Elements of the described embodiment shown in software may be implemented in hardware and vice versa.

It will be appreciated by those skilled in the art that changes could be made to the embodiments described above without departing from the broad inventive concept thereof. For example, the steps or order of operation of one of the above-described methods could be rearranged or occur in a different series, as understood by those skilled in the art. It is understood, therefore, that this disclosure is not limited to the particular embodiments disclosed, but it is intended to cover modifications within the spirit and scope of the present disclosure.

1. A method executed by one or more computing devices of a controller of a tokenized transfer network for determining authorized token transfers, the method comprising:
determining, by the controller, a plurality of network-host parameters corresponding to a network-host of the tokenized transfer network;
determining, by the controller, a plurality of network-client parameters corresponding to a network-client registered with the tokenized transfer network;
generating, by the controller, a parameterized model based at least in part on the plurality of network-host parameters and the plurality of network-client parameters, the parameterized model being generated by integrating the plurality of network-host parameters and the plurality of network-client parameters into an authorized token transfer generation subroutine;
receiving, by the controller, a plurality of transfer data structures, each transfer data structure identifying a first entity having requirements associated with a transfer to a second entity, the second entity having collection authority to receive the transfer from the first entity, and one or more transfer parameters governing the transfer; and
applying the parameterized model to the plurality of transfer data structures to determine a plurality of network-client adjustment rates and a plurality of authorized token transfers, each network-client adjustment rate and each authorized token transfer corresponding to a transfer data structure in the plurality of transfer data structures;
wherein each authorized token transfer comprises a transmission of a non-fungible token (NFT) from a distributed ledger address of a second entity identified by the corresponding transfer data structure to a distributed ledger address of the network-client and wherein transmission of the NFT transfers collection authority for the corresponding transfer data structure from the second entity to the network-client in exchange for a reverse transfer from the network-client to the second entity.

2. The method of claim 1, wherein applying the parameterized model to the plurality of transfer data structures to determine a plurality of network-client adjustment rates and a plurality of authorized token transfers comprises:
removing one or more transfer data structures from the plurality of transfer data structures based at least in part on one or more network-client parameters in the plurality of network-client parameters to generate a plurality of remaining transfer data structures; and
applying the parameterized model to the plurality of remaining transfer data structures to determine the plurality of network-client adjustment rates and the plurality of authorized token transfers.

3. The method of claim 2, wherein applying the parameterized model to the plurality of remaining transfer data structures to determine the plurality of network-client adjustment rates and the plurality of authorized token transfers comprises, for each transfer data structure in the plurality of remaining transfer data structures:
identifying a first entity profile on the tokenized transfer network based at least in part on a first entity identifier of a first entity identified by the transfer data structure and a second entity profile on the tokenized transfer network based at least in part on a second entity identifier of a second entity identified by the transfer data structure, the first entity profile comprising a first entity transfer history and the second entity profile comprising a second entity transfer history;
determining, by at least one of the one or more computing device, the network-client adjustment and the authorized token transfer for the transfer data structure based at least in part on the first entity transfer history and the second entity transfer history.

4. The method of claim 2, wherein applying the parameterized model to the plurality of remaining transfer data structures to determine the plurality of network-client adjustment rates and the plurality of authorized token transfers further comprises:
storing a current total reverse transfer value corresponding to a sum of reverse transfers, the current total reverse transfer value being dynamically updated as additional authorized token transfers are determined;
grouping the plurality of remaining transfer data structures into a plurality of arrival-time cohorts according to an arrival time of each transfer data structure in the plurality of remaining transfer data structures;
iteratively determining authorized token transfers corresponding to remaining transfer data structures in each arrival-time cohort on a rolling basis in chronological order of arrival time of each arrival-time cohort based at least in part on a determination that the authorized token transfer would not result in the current total reverse transfer value exceeding a network-client parameter in the plurality of network-client parameters;
transmitting any transfer data structures not having a corresponding authorized token transfer for downstream processing.

5. The method of claim 1, further comprising:
transmitting the plurality of authorized token transfers to one or more second entities identified in a plurality of transfer data structures corresponding to the plurality of authorized token transfers;
receiving at least one approval of at least one authorized token transfer in the one or more authorized token transfers from at least one second entity in the one or more second entities; and
initiating the reverse transfer corresponding to the at least one authorized token transfer from the network-client to the at least one second entity and the at least one authorized token transfer from the at least one second entity to the network-client.

6. The method of claim 1, further comprising:
grouping the plurality of authorized token transfers according to second entity to generate one or more groups of authorized token transfers corresponding to one or more second entities;
aggregating each group of authorized token transfers in the one or more groups of authorized token transfers to generate one or more aggregate authorized token transfers;
transmitting the one or more aggregate authorized token transfers to the one or more second entities;
receiving at least one approval of at least a portion of an aggregate authorized token transfer in the one or more aggregate authorized token transfers from at least one second entity in the one or more second entities; and
initiating a reverse transfer corresponding the aggregate authorized token transfer from the network-client to the at least one second entity.

7. A controller of a tokenized transfer network for determining authorized token transfers, the controller comprising:
one or more processors; and
one or more memories operatively coupled to at least one of the one or more processors and having instructions stored thereon that, when executed by at least one of the one or more processors, cause at least one of the one or more processors to:
determine a plurality of network-host parameters corresponding to a network-host of the tokenized transfer network;
determine a plurality of network-client parameters corresponding to a network-client registered with the tokenized transfer network;
generate a parameterized model based at least in part on the plurality of network-host parameters and the plurality of network-client parameters, the parameterized model being generated by integrating the plurality of network-host parameters and the plurality of network-client parameters into an authorized token transfer generation subroutine;
receive a plurality of transfer data structures, each transfer data structure identifying a first entity having requirements associated with a transfer to a second entity, the second entity having collection authority to receive the transfer from the first entity, and one or more transfer parameters governing the transfer; and
apply the parameterized model to the plurality of transfer data structures to determine a plurality of network-client adjustment rates and a plurality of authorized token transfers, each network-client adjustment rate and each authorized token transfer corresponding to a transfer data structure in the plurality of transfer data structures;
wherein each authorized token transfer comprises a transmission of a non-fungible token (NFT) from a distributed ledger address of a second entity identified by the corresponding transfer data structure to a distributed ledger address of the network-client and wherein transmission of the NFT transfers collection authority for the corresponding transfer data structure from the second entity to the network-client in exchange for a reverse transfer from the network-client to the second entity.

8. At least one non-transitory computer-readable medium storing computer-readable instructions that, when executed by one or more computing devices of a controller of a tokenized transfer network, cause the controller to:
determine a plurality of network-host parameters corresponding to a network-host of the tokenized transfer network;
determine a plurality of network-client parameters corresponding to a network-client registered with the tokenized transfer network;
generate a parameterized model based at least in part on the plurality of network-host parameters and the plurality of network-client parameters, the parameterized model being generated by integrating the plurality of network-host parameters and the plurality of network-client parameters into an authorized token transfer generation subroutine;
receive a plurality of transfer data structures, each transfer data structure identifying a first entity having requirements associated with a transfer to a second entity, the second entity having collection authority to receive the transfer from the first entity, and one or more transfer parameters governing the transfer; and
apply the parameterized model to the plurality of transfer data structures to determine a plurality of network-client adjustment rates and a plurality of authorized token transfers, each network-client adjustment rate and each authorized token transfer corresponding to a transfer data structure in the plurality of transfer data structures;
wherein each authorized token transfer comprises a transmission of a non-fungible token (NFT) from a distributed ledger address of a second entity identified by the corresponding transfer data structure to a distributed ledger address of the network-client and wherein transmission of the NFT transfers collection authority for the corresponding transfer data structure from the second entity to the network-client in exchange for a reverse transfer from the network-client to the second entity.
